(19) United States
(12) Patent Application Publication
(10) Pub. No.: US 2014/0123308 A1
(43) Pub. Date: May 1, 2014

(54) METHODS AND SYSTEMS FOR MANAGING DATA AND/OR SERVICES FOR DEVICES

(71) Applicants: Edward K.Y. Jung, Bellevue, WA (US); Royce A. Levien, Lexington, MA (US); Richard T. Lord, Tacoma, WA (US); Robert W. Lord, Seattle, WA (US); Mark A. Malamud, Seattle, WA (US)

(72) Inventors: Edward K.Y. Jung, Bellevue, WA (US); Royce A. Levien, Lexington, MA (US); Richard T. Lord, Tacoma, WA (US); Robert W. Lord, Seattle, WA (US); Mark A. Malamud, Seattle, WA (US)

(73) Assignee: Elwha LLC, Bellevue, WA (US)

(21) Appl. No.: 13/731,968

(22) Filed: Dec. 31, 2012

Related U.S. Application Data
(63) Continuation-in-part of application No. 13/685,485, filed on Nov. 26, 2012.
Application No. 13/685,485 is a continuation-in-part of application No. 13/685,609, filed on Nov. 26, 2012.
Application No. 13/685,609 is a continuation-in-part of application No. 13/685,488, filed on Nov. 26, 2012.
Application No. 13/685,488 is a continuation-in-part of application No. 13/685,612, filed on Nov. 26, 2012.
Application No. 13/685,612 is a continuation-in-part of application No. 13/685,491, filed on Nov. 26, 2012.
Application No. 13/685,491 is a continuation-in-part of application No. 13/685,613, filed on Nov. 26, 2012.
Application No. 13/685,613 is a continuation-in-part of application No. 13/692,829, filed on Dec. 3, 2012.
Application No. 13/692,829 is a continuation-in-part of application No. 13/692,882, filed on Dec. 3, 2012.
(60) Provisional application No. 13/968,729.

(51) Int. Cl. G06F 21/62

(52) U.S. Cl. CPC G06F 21/62
USPC 726/27

(57) ABSTRACT

Computationally implemented methods and systems include determining that a device has particular data that is designated as potentially valuable wherein access to the particular data is restricted, determining one or more services configured to be carried out on the device, said one or more services using the particular data to which the access is restricted, and facilitating presentation of an offer to facilitate carrying out one or more services that use the particular data. In addition to the foregoing, other aspects are described in the claims, drawings, and text.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application claims benefit of priority of U.S. Provisional Patent Application No. 61/720,245 titled METHODS AND SYSTEMS FOR DATA SERVICES, naming Edward K. Y. Jung, Royce A. Levien, Richard T. Lord, Robert W. Lord, and Mark A. Malamud as inventors, filed 30 Oct. 2012, which was filed within the twelve months preceding the filing date of the present application or is an application of which a currently co-pending application is entitled to the benefit of the filing date.

For purposes of the USPTO extra-statutory requirements, the present application claims benefit of priority of U.S. Provisional Patent Application No. 61/720,874 titled METHODS AND SYSTEMS FOR DATA SERVICES, naming Edward K. Y. Jung, Royce A. Levien, Richard T. Lord, Robert W. Lord, and Mark A. Malamud as inventors, filed 31 Oct. 2012, which was filed within the twelve months preceding the filing date of the present application or is an application of which a currently co-pending application is entitled to the benefit of the filing date.

For purposes of the USPTO extra-statutory requirements, the present application constitutes a continuation-in-part of U.S. patent application Ser. No. 13/685,485, entitled METHODS AND SYSTEMS FOR MANAGING DATA, naming Edward K. Y. Jung, Royce A. Levien, Richard T. Lord, Robert W. Lord, and Mark A. Malamud as inventors, filed 26 Nov. 2012 with attorney docket no. 0712-003-013-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/685,609, entitled METHODS AND SYSTEMS FOR MANAGING DATA, naming Edward K. Y. Jung, Royce A. Levien, Richard T. Lord, Robert W. Lord, and Mark A. Malamud as inventors, filed 26 Nov. 2012 with attorney docket no. 0712-003-013-000001, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/685,488, entitled METHODS AND SYSTEMS FOR MANAGING DATA, naming Edward K. Y. Jung, Royce A. Levien, Richard T. Lord, Robert W. Lord, and Mark A. Malamud as inventors, filed 26 Nov. 2012 with attorney docket no. 0712-003-014-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/685,612, entitled METHODS AND SYSTEMS FOR MANAGING DATA, naming Edward K. Y. Jung, Royce A. Levien, Richard T. Lord, Robert W. Lord, and Mark A. Malamud as inventors, filed 26 Nov. 2012 with attorney docket no. 0712-003-014-000001, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/685,491, entitled METHODS AND SYSTEMS FOR MANAGING DATA, naming Edward K. Y. Jung, Royce A. Levien, Richard T. Lord, Robert W. Lord, and Mark A. Malamud as inventors, filed 26 Nov. 2012 with attorney docket no. 0712-003-015-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/685,613, entitled METHODS AND SYSTEMS FOR MANAGING DATA, naming Edward K. Y. Jung, Royce A. Levien, Richard T. Lord, Robert W. Lord, and Mark A. Malamud as inventors, filed 26 Nov. 2012 with attorney docket no. 0712-003-015-000001, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/692,829, entitled METHODS AND SYSTEMS FOR MANAGING DEVICE DATA, naming Edward K. Y. Jung, Royce A. Levien, Richard T. Lord, Robert W. Lord, and Mark A. Malamud as inventors, filed 3 Dec. 2012 with attorney docket no. 0712-003-016-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/692,882, entitled METHODS AND SYSTEMS FOR MANAGING DEVICE DATA, naming Edward K. Y. Jung, Royce A. Levien, Richard T. Lord, Robert W. Lord, and Mark A. Malamud as inventors, filed 3 Dec. 2012 with attorney docket no. 0712-003-016-000001, which is currently co-pending or is an application of which a currently co-pending application is entitled to the benefit of the filing date.

### RELATED APPLICATIONS

U.S. patent application Ser. No. TO BE ASSIGNED, entitled METHODS AND SYSTEMS FOR MANAGING ONE OR MORE SERVICES AND/OR DEVICE DATA, naming Edward K. Y. Jung, Royce A. Levien, Richard T. Lord, Robert W. Lord, and Mark A. Malamud as inventors, filed 31 Dec. 2012 with attorney docket no. 0712-003-017-000000, is related to the present application.

U.S. patent application Ser. No. TO BE ASSIGNED, entitled METHODS AND SYSTEMS FOR MANAGING ONE OR MORE SERVICES AND/OR DEVICE DATA, naming Edward K. Y. Jung, Royce A. Levien, Richard T. Lord, Robert W. Lord, and Mark A. Malamud as inventors, filed 31 Dec. 2012 with attorney docket no. 0712-003-017-000001, is related to the present application.

U.S. patent application Ser. No. TO BE ASSIGNED, entitled METHODS AND SYSTEMS FOR MANAGING SERVICES AND DEVICE DATA, naming Edward K. Y. Jung, Royce A. Levien, Richard T. Lord, Robert W. Lord, and Mark A. Malamud as inventors, filed 31 Dec. 2012 with attorney docket no. 0712-003-018-000000, is related to the present application.

U.S. patent application Ser. No. TO BE ASSIGNED, entitled METHODS AND SYSTEMS FOR MANAGING SERVICES AND DEVICE DATA, naming Edward K. Y. Jung, Royce A. Levien, Richard T. Lord, Robert W. Lord, and Mark A. Malamud as inventors, filed 31 Dec. 2012 with attorney docket no. 0712-003-018-000001, is related to the present application.

U.S. patent application Ser. No. TO BE ASSIGNED, entitled METHODS AND SYSTEMS FOR MANAGING DATA AND/OR SERVICES FOR DEVICES, naming Edward K. Y. Jung, Royce A. Levien, Richard T. Lord, Robert W. Lord, and Mark A. Malamud as inventors, filed 31 Dec. 2012 with attorney docket no. 0712-003-019-C00001, is related to the present application.

U.S. patent application Ser. No. TO BE ASSIGNED, entitled METHODS AND SYSTEMS FOR MONITORING AND/OR MANAGING DEVICE DATA, naming Edward K. Y. Jung, Royce A. Levien, Richard T. Lord, Robert W. Lord, and Mark A. Malamud as inventors, filed 31 Dec. 2012 with attorney docket no. 0712-003-020-000000, is related to the present application.

U.S. patent application Ser. No. TO BE ASSIGNED, entitled METHODS AND SYSTEMS FOR MONITORING AND/OR MANAGING DEVICE DATA, naming Edward K. Y. Jung, Royce A. Levien, Richard T. Lord, Robert W. Lord, and Mark A. Malamud as inventors, filed 31 Dec. 2012 with attorney docket no. 0712-003-020-C00001, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BACKGROUND

This application is related to data services.

### SUMMARY

In one or more various aspects, a method includes but is not limited to determining that a device has particular data that is designated as potentially valuable wherein access to the particular data is restricted, determining one or more services configured to be carried out on the device, said one or more services using the particular data to which the access is restricted, facilitating presentation of an offer to facilitate carrying out one or more services that use the particular data, and acquiring the particular data designated as potentially valuable by facilitating carrying out the one or more services that are configured to use at least a portion of the particular data in a course of carrying out the one or more services. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for determining that a device has particular data that is designated as potentially valuable wherein access to the particular data is restricted, means for determining one or more services configured to be carried out on the device, said one or more services using the particular data to which the access is restricted, means for facilitating presentation of an offer to facilitate carrying out one or more services that use the particular data, and means for acquiring the particular data designated as potentially valuable by facilitating carrying out the one or more services that are configured to use at least a portion of the particular data in a course of carrying out the one or more services. In addition to the foregoing, other system aspects are described in the claims, drawings, and text forming a part of the disclosure set forth herein.

In one or more various aspects, a system includes, but is not limited to, circuitry for determining that a device has particular data that is designated as potentially valuable wherein access to the particular data is restricted, circuitry for determining one or more services configured to be carried out on the device, said one or more services using the particular data to which the access is restricted, circuitry for facilitating presentation of an offer to facilitate carrying out one or more services that use the particular data, and acquiring the particular data designated as potentially valuable by facilitating carrying out the one or more services that are configured to use at least a portion of the particular data in a course of carrying out the one or more services. In addition to the foregoing, other system aspects are described in the claims, drawings, and text forming a part of the disclosure set forth herein.

In one or more various aspects, a computer program product, comprising a signal bearing medium, bearing one or more instructions including, but not limited to, one or more instructions for determining that a device has particular data that is designated as potentially valuable wherein access to the particular data is restricted, one or more instructions for determining one or more services configured to be carried out on the device, said one or more services using the particular data to which the access is restricted, and one or more instructions for facilitating presentation of an offer to facilitate carrying out one or more services that use the particular data, and one or more instructions for acquiring the particular data designated as potentially valuable by facilitating carrying out the one or more services that are configured to use at least a portion of the particular data in a course of carrying out the one or more services. In addition to the foregoing, other computer program product aspects are described in the claims, drawings, and text forming a part of the disclosure set forth herein.

In one or more various aspects, a device is defined by a computational language, such that the device comprises one or more interchained physical machines ordered for determining that a device has particular data that is designated as potentially valuable wherein access to the particular data is restricted, one or more interchained physical machines ordered for determining one or more services configured to be carried out on the device, said one or more services using the particular data to which the access is restricted, one or more interchained physical machines ordered for facilitating presentation of an offer to facilitate carrying out one or more services that use the particular data, and one or more interchained physical machines ordered for acquiring the particular data designated as potentially valuable by facilitating carrying out the one or more services that are configured to use at least a portion of the particular data in a course of carrying out the one or more services.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1A shows a high-level block diagram of an exemplary environment 100, according to an embodiment.

FIG. 1B shows a high-level block diagram of a computing device 130 operating in an exemplary environment 100, according to an embodiment.

FIG. 1C shows a high level block diagram of a computing device 130A operating in an exemplary embodiment 100′, according to an embodiment.

FIG. 1D shows a high-level block diagram of a computing device 130B operating in an exemplary embodiment 100″, according to an embodiment.

FIG. 1E shows a high-level block diagram of a computing device 130C operating in an exemplary embodiment 100′″, according to an embodiment.

FIG. 1F shows a high-level block diagram of a computing device 130D operating in an exemplary embodiment 100″″, according to an embodiment.

FIG. 2, including FIGS. 2A-2F, shows a particular perspective of a particular data indicated as potentially valuable data presence on a device with restricted access finding module 152 of processing module 150 of computing device 130 of FIG. 1B, according to an embodiment.

FIG. 3, including FIGS. 3A-3B, shows a particular perspective of a one or more device-based services configured to utilize particular data indicated as potentially valuable determining module 154 of processing module 150 of computing device 130 of FIG. 1B, according to an embodiment.

FIG. 4, including FIGS. 4A-4B, shows a particular perspective of an presentation of an offer of one or more device-based services using the particular data to the device facilitating module 156 of processing module 150 of computing device 130 of FIG. 1B, according to an embodiment.

FIG. 5, including FIGS. 5A-5B, shows a particular perspective of an access to particular data indicated as potentially valuable obtaining by facilitating execution of the one or more determined device-based services module 158 of processing module 150 of computing device 130 of FIG. 1B, according to an embodiment.

FIG. 6 is a high-level logic flowchart of a process, e.g., operational flow 600, according to an embodiment.

FIG. 7A is a high-level logic flow chart of a process depicting alternate implementations of a determining that a device has particular data operation 602, according to one or more embodiments.

FIG. 7B is a high-level logic flow chart of a process depicting alternate implementations of a determining that a device has particular data operation 602, according to one or more embodiments.

FIG. 7C is a high-level logic flow chart of a process depicting alternate implementations of a determining that a device has particular data operation 602, according to one or more embodiments.

FIG. 7D is a high-level logic flow chart of a process depicting alternate implementations of a determining that a device has particular data operation 602, according to one or more embodiments.

FIG. 7E is a high-level logic flow chart of a process depicting alternate implementations of a determining that a device has particular data operation 602, according to one or more embodiments.

FIG. 7F is a high-level logic flow chart of a process depicting alternate implementations of a determining that a device has particular data operation 602, according to one or more embodiments.

FIG. 8A is a high-level logic flow chart of a process depicting alternate implementations of a determining one or more services operation 604, according to one or more embodiments.

FIG. 8B is a high-level logic flow chart of a process depicting alternate implementations of a determining one or more services operation 604, according to one or more embodiments.

FIG. 9A is a high-level logic flow chart of a process depicting alternate implementations of a facilitating presentation of an offer operation 606, according to one or more embodiments.

FIG. 9B is a high-level logic flow chart of a process depicting alternate implementations of a facilitating presentation of an offer operation 606, according to one or more embodiments.

FIG. 9C is a high-level logic flow chart of a process depicting alternate implementations of a facilitating presentation of an offer operation 606, according to one or more embodiments.

FIG. 10A is a high-level logic flow chart of a process depicting alternate implementations of an acquiring the particular data operation 608, according to one or more embodiments.

FIG. 10B is a high-level logic flow chart of a process depicting alternate implementations of an acquiring the particular data operation 608, according to one or more embodiments.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for determining that a device has particular data that is designated as potentially valuable wherein access to the particular data is restricted, determining one or more services configured to be carried out on the device, said one or more services using the particular data to which the access is restricted, facilitating presentation of an offer to facilitate carrying out one or more services that use the particular data, and acquiring the particular data designated as potentially valuable by facilitating carrying out the one or more services that are configured to use at least a portion of the particular data in a course of carrying out the one or more services.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

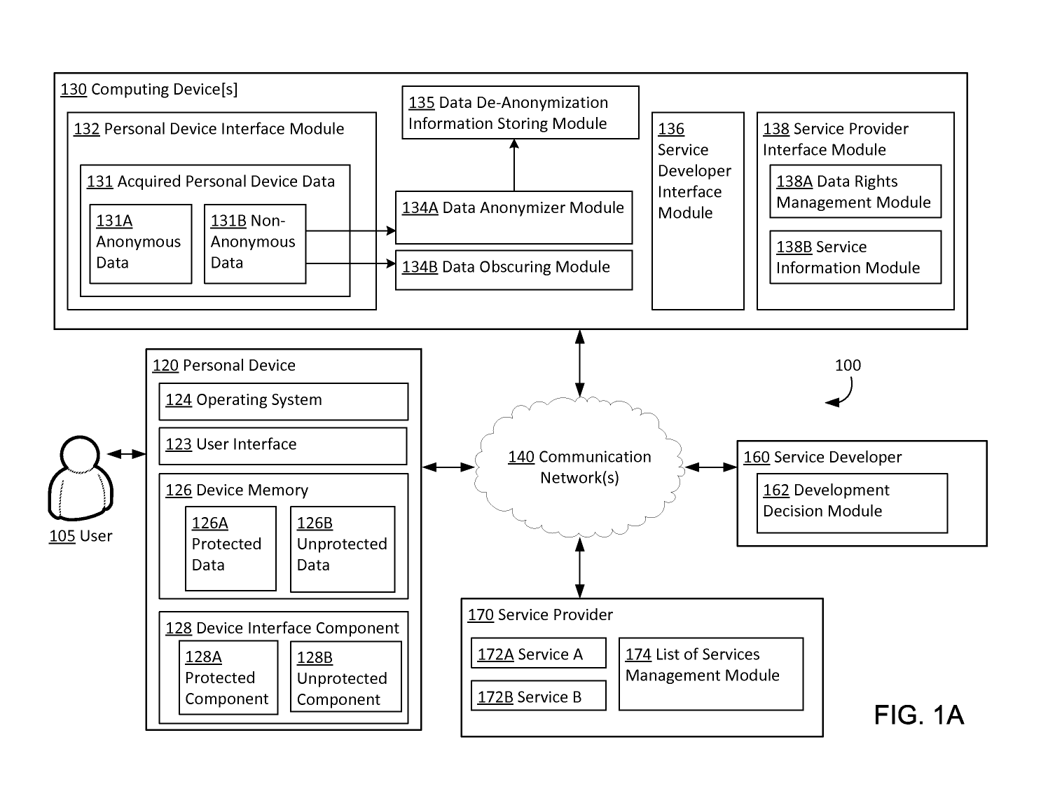

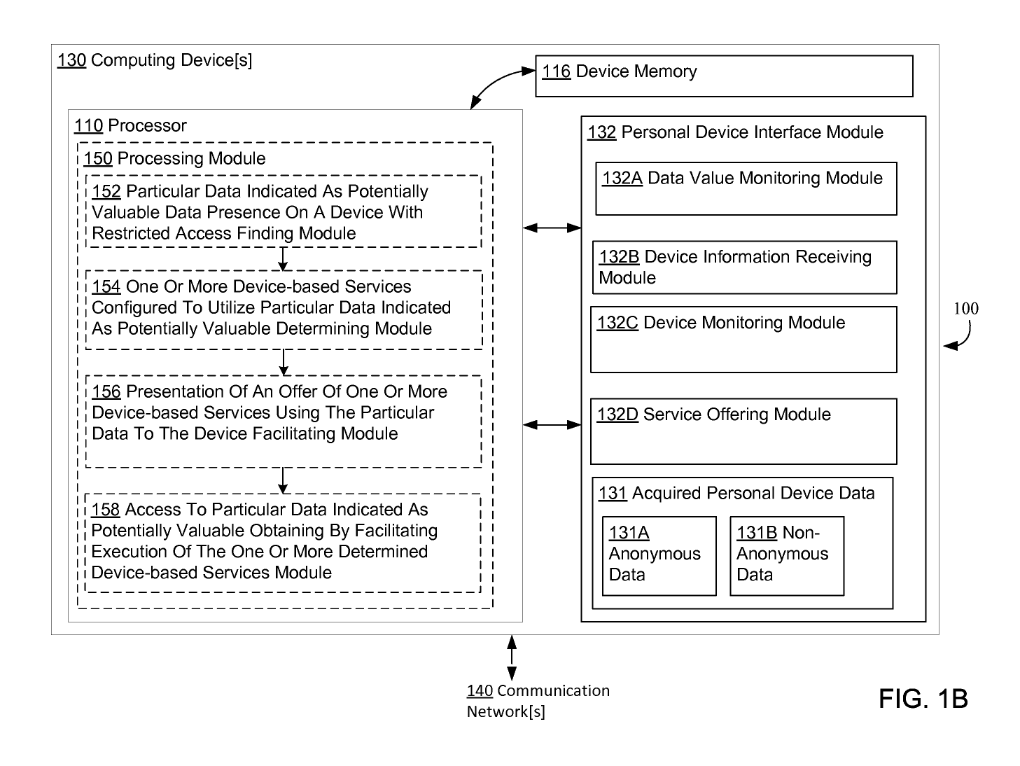

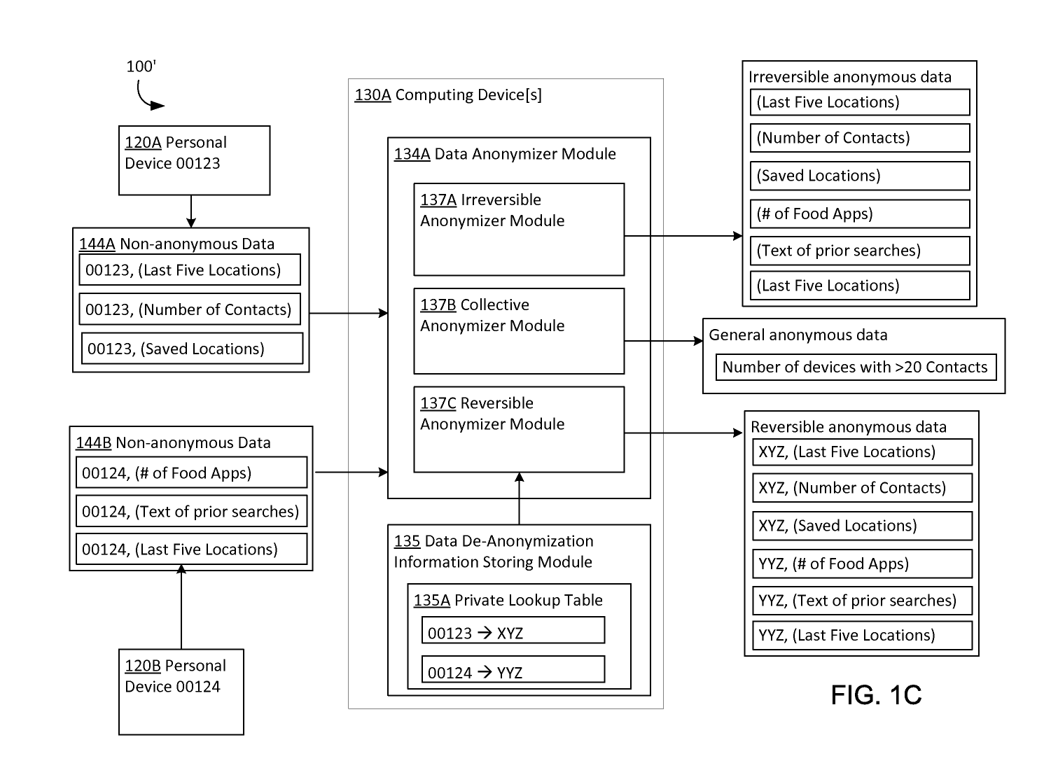

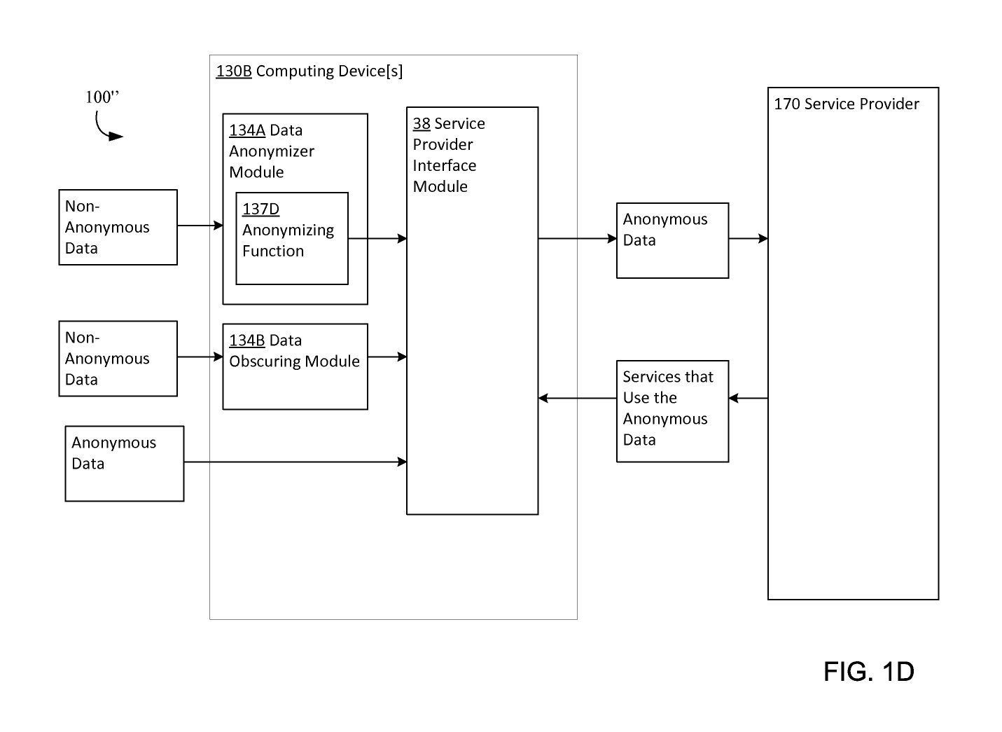

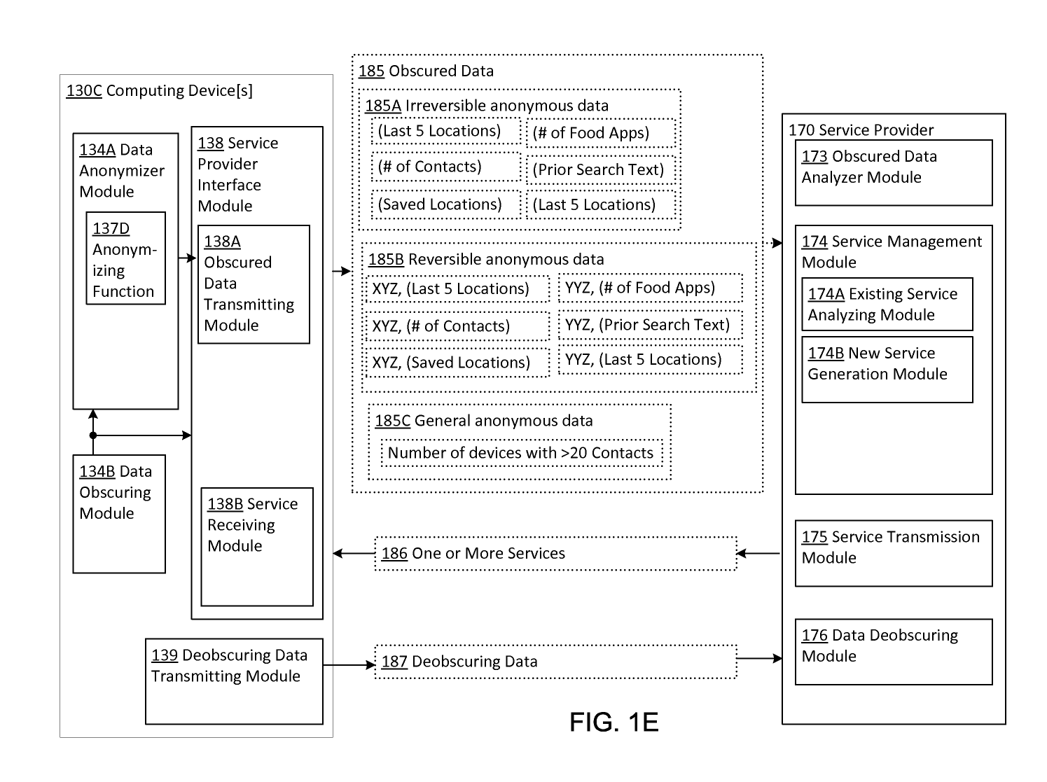

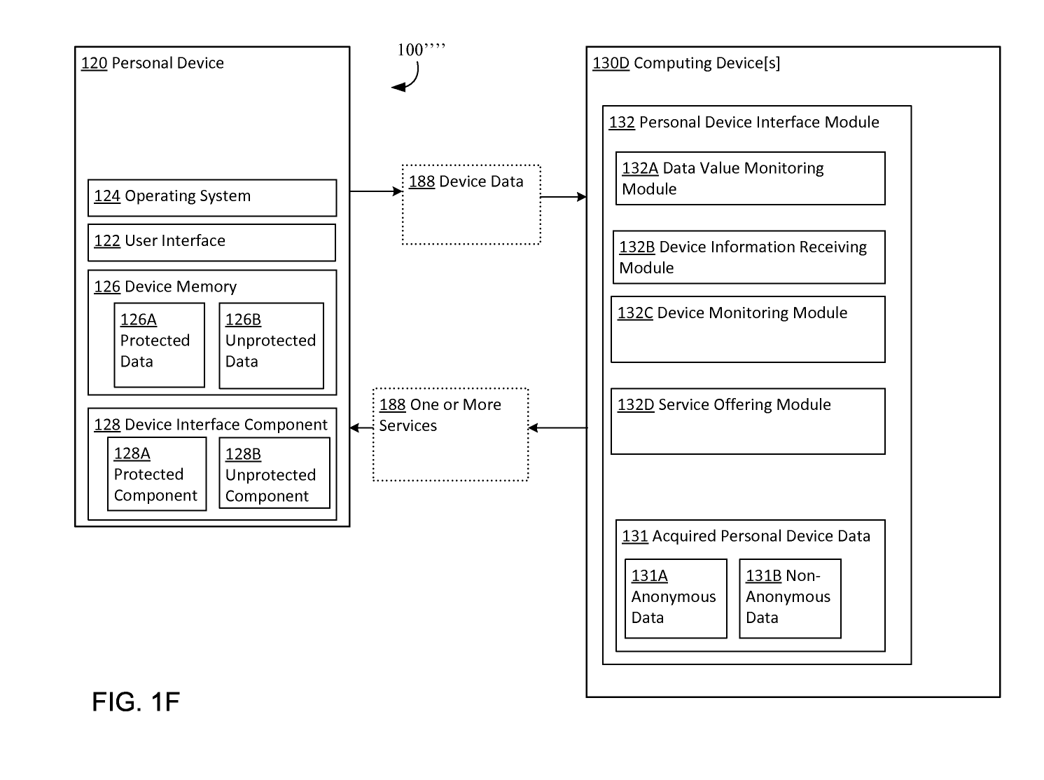

Although user 105 is shown/described herein, e.g., in FIG. 1, and other places, as a single illustrated figure, those skilled in the art will appreciate that user 105 may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

In known systems, devices that are associated with one or more users, e.g., phones, tablets, laptops, desktops, cars, game systems, appliances, and the like, may collect data regarding the user. This data may be desired by third parties. The following describes, among other implementations, methods and systems of managing user data collected by one or more devices that may also be useful to entities that are not the user, and which entities may not necessarily have access to the data.

Referring now to FIG. 1, FIG. 1 illustrates an example environment 100 in which the methods, systems, circuitry, articles of manufacture, and computer program products and architecture, in accordance with various embodiments, may be implemented by one or more computing devices 130. As shown in FIG. 1A, one or more personal devices 120, one or more service providers 170, one or more service developers 160, and one or more computing devices 30 may communicate via one or more communication networks 140. In an embodiment, service provider 170 may have one or more services that personal device 120 may want. In an embodiment, computing device 130, which may be a remote or local server, or distributed set of servers, may manage data that is gathered, stored, controlled, accessed, restricted, monitored, under the control of, checked, examined, verified, authenticated, authorized, manipulated, updated, altered, filtered, or otherwise acted upon, whether passively or actively, by personal device 20. In an embodiment, as described in more detail herein, computing device 130 may have access to some or all of the data on personal device 120. In another embodiment, computing device 130 may have access to only a portion of the data on personal device 120. In still another embodiment, computing device 130 may have access to a modified version of the data on personal device 120. Specifically, in an embodiment, computing device 20 may have access to the data stored on personal device 120, but in anonymous form.

In an embodiment, computing device 130 may offer one or more services to personal device 120. In an embodiment, the offer of one or more services may be conditional on a grant of access to part or all of the data stored and/or collected by personal device 120. In an embodiment, computing device 30 may receive one or more services from service provider 170 and/or service developer 160, and may select one or more of the received services for presentation to the personal device 120. In an embodiment, the data from personal device 120 may be shared with one or more of service provider 170 and service developer 160. In an embodiment, the data from personal device 120 may be anonymized prior to sharing with service developer 160 and/or service developer 170.

Referring again to FIG. 1A, FIG. 1A shows a personal device 120. Personal device 120 may be any electronic device, portable or not, that may be operated by or associated with one or more users. Personal device 120 is shown as interacting with a user 105. As set forth above, user 105 may be a person, or a group of people, or another entity that mimics the operations of a user. In some embodiments, user 105 may be a computer or a computer-controlled device. Personal device 120 may be, but is not limited to, a cellular phone, a network phone, a smartphone, a tablet, a music player, a walkie-talkie, a radio, a USB drive, a portable solid state drive, a portable disc-type hard drive, an augmented reality device (e.g., augmented reality glasses and/or headphones), earphones, headphones, audio/visual equipment, media player, television, projection screen, flat screen, monitor, clock, appliance (e.g., microwave, convection oven, stove, refrigerator, freezer), a navigation system (e.g., a Global Positioning System (“GPS”) system), a medical alert device, a remote control, a peripheral, an electronic safe, an electronic lock, an electronic security system, a video camera, a personal video recorder, a personal audio recorder, and the like.

Referring again to FIG. 1A, personal device 120 may include an operating system 124. In this context, operating system 124 refers to any hardware, software, firmware, and combination thereof which is considered at the core or baseline of a device. For example, applications that interact directly with hardware may be considered to be part of an operating system. In some embodiments, operating system 124 may be an FPGA, printed circuit board, or other wired device. In an embodiment, operating system 124 may include one or more of Google's Android, Apple's iOS, Microsoft's Windows, various implementations of Linux, and the like. In some embodiments, operating system 124 may include a root menu for one or more televisions, stereo systems, media players, and the like. In some embodiments, operating system 124 may be a “home” screen of a device.

Referring again to FIG. 1A, in an embodiment, personal device 20 may include a user interface 123. User interface 123 may include any hardware, software, firmware, and combination thereof that allow a user 105 to interact with a personal device 120, and for a personal device 120 to interact with a user 105. In some embodiments, user interface 123 may include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, and the like.

Referring again to FIG. 1A, in some embodiments, personal device 120 may include a device memory 126. In some embodiments, device memory 126 may include memory, random access memory (“RAM”), read only memory (“ROM”), flash memory, hard drives, disk-based media, disc-based media, magnetic storage, optical storage, volatile memory, nonvolatile memory, and any combination thereof. In some embodiments, device memory 126 may be separated from the device, e.g., available on a different device on a network, or over the air. For example, in a networked system, there may be many personal devices 120 whose device memory 126 is located at a central server that may be a few feet away or located across an ocean.

Referring again to FIG. 1A, in some embodiments, device memory 126 may include one or more of protected data 126A and unprotected data 126B. Not all embodiments include each or both of these, but protected data 126A and unprotected data 126B may be present in one or more embodiments. Protected data 126A may include any data, including data stored on personal device 120, data for which personal device 120 maintains at least partial control of, data for which personal device 120 monitors or provides the ability to monitor, and the like, for which some form of authorization is required to access the data. The authorization may take any form and relate to any sub-unit, including both internally and externally to the device. For example, in an embodiment, protected data 126A may include data which is not available to at least one application running on a computing device. For another example, in an embodiment, protected data 126A may be available to one application at any time, and to another application at specific times, or at times when the first application is not using the data. In an embodiment, protected data 126A includes data for which an application must be authenticated (e.g., a Microsoft operating system certification, or a user flag set to true) in order to access the protected data 126A.

In an embodiment, protected data 126A includes data that a user, e.g., user 105, cannot view until the user 105 verifies their identity, e.g., through a password input or biometric identification. In an embodiment, protected data 126A is limited to the device, and is not transmitted to any other system not under the direct control of the personal device 120. In an embodiment, protected data 126A is limited to the personal device 120, and only applications originating at the personal device 120, or originating with the user 105, are allowed to read protected data 126A. In an embodiment, personal device 120 modifies or directs to be modified protected data 126A, so at least a portion of the protected data 126A is altered or obscured. In an embodiment, personal device 120 allows protected data 126A to be transmitted to an external entity under the condition that the external entity will alter or obscure at least a portion of the protected data 126A.

Referring again to FIG. 1A, in an embodiment, personal device 120 may include device memory 126, which, in some embodiments, may include unprotected data 26B. In an embodiment, unprotected data 126B may have no protections or limitations. In another embodiment, unprotected data 126B may have protections and limitations, but be less protected and/or less limited than protected data 126B. In an embodiment, unprotected data 126B is broadcasted or otherwise transmitted upon request. In an embodiment, unprotected data 126B cannot be accessed by an entity external to personal device 120 due to device design or other factors, but there is no specific protection on unprotected data 126B from access by one or more entities external to personal device 20.

Referring again to FIG. 1A, in an embodiment, personal device 120 may include device interface component 128. In an embodiment, device interface component 128 includes any component that allows the device to interact with its environment. For example, in an embodiment, device interface component 128 includes one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, and the like. In an embodiment, device interface component 128 also may include one or more user interface components, e.g., user interface 122 (e.g., although they are drawn separately, in some embodiments, user interface 122 is a type of device interface component 128), and in some embodiments including one or more user input receiving components and output presenting components.

Referring again to FIG. 1A, in an embodiment, device interface component 128 may include protected component 128A. Protected component 128A may include any device interface component 128, of which some non-limiting examples previously were enumerated, for which some form of authorization and/or authentication is required to access the data. The authorization may take any form and relate to any sub-unit, including both internally and externally to the device. In an embodiment, protected component 128A is similar to protected data 126A. For example, in an embodiment, a personal device 120, e.g., a smart phone, may have twelve applications running on the smartphone. In an embodiment, six of those applications may have access to a protected component 128A, e.g., a positioning sensor, and the other six may not. In some embodiments, data collected by a protected component 128A is part of the protected component 128A. In some embodiments, data collected by a protected component 128A becomes protected data 126A. In some embodiments, data collected by a protected component 128A becomes protected data 126A some of the time, or none of the time. In some embodiments, data collected by a protected component 128A may be part of protected component 128A for a particular amount of time, e.g., two weeks, and then may transition to unprotected data or data that is not considered protected or unprotected. In some embodiments, a protected component 128A may be accessible to everyone at particular times and/or circumstances. For example, a protected component 128A, e.g., a wireless radio, may be accessible to any entity between the hours of 7 and 8 pm, and only accessible to specific entities and/or applications at other times. In some embodiments, a protected component 128A, e.g., an image capturing component, may be accessible to any entity when one or more conditions are met, which conditions may or may not be related to the protected component 128A or the personal device 120, e.g., when the personal device 120 is at a particular location.

Referring again to FIG. 1A, in some embodiments, computing device 30 may include personal device interface module 132. In some embodiments, personal device interface module 132 may communicate with one or more personal devices 120. In some embodiments, personal device interface module 132 may receive data 131 received from a personal device 120. Acquired personal device data 131 may include any data gathered from personal device 120, in any manner. In some embodiments, computing device 30 may request data from personal device 120. In some embodiments, computing device 30 may receive data from personal device 120 on a schedule. In some embodiments, computing device 130 may retrieve data from personal device 120 when certain conditions are met. In some embodiments, personal device 120 is broadcasting data, and computing device 130 gathers the broadcasted data. In some embodiments, personal device 120 broadcasts data that only computing device 130 can use (e.g., decrypt, interpret, or the like). In some embodiments, personal device 120 may transmit acquired personal device data 131 to computing device 30 using one or more communication networks 140, which will be described in more detail herein.

Referring again to FIG. 1A, in some embodiments, the acquired personal device data 131 may be anonymous data 131A. In an embodiment, anonymous data refers to data from which the origin of the data cannot be uniquely identified. In some embodiments, the origin of the data may refer to the personal device 120, e.g., a unique identifier, e.g., a MAC address. In some embodiments, the origin of the data may refer to a user 105 associated with the data, either through ownership, use, or other relationship with the device, e.g., a username, a user's name, or a user's social security or other identifying number, or network address or identification. It is noted that, in some embodiments, the device may be able to recognize the origin of the data, e.g., an identity of personal device 120, that is transmitting the data due to the nature of the data transmission, but be unable to deduce the origin of the data through the data itself, in which case, in some embodiments, this data is still considered anonymous data 131A.

Anonymous data 131A may include data for which uniquely identifying information has been removed, or data for which uniquely identifying information has been concealed, obscured, made uncertain, made ambiguous, screened, camouflaged, masked, veiled, shrouded, hidden, encoded, encrypted, or otherwise altered. In some embodiments, the received anonymous data 131A never included uniquely identifying information. In some embodiments, anonymous data 131A may partially or non-uniquely identify its origin, e.g., the user 105 or the personal device 120 from which the anonymous data came. In some embodiments, uniquely identifying information may be extracted from anonymous data 131A using additional information, e.g., a lookup table, hash, or other known algorithm. In some embodiments, uniquely identifying information may be deduced from anonymous data 131A without additional information. In some embodiments, uniquely identifying information may not be retrieved from anonymous data 131A once the data is in its anonymous format.

In an embodiment, acquired personal device data 131 may include non-anonymous data 131B. In some embodiments, non-anonymous data 131B may identify, either explicitly or implicitly, the origin of the data. In some embodiments, the origin of the data may refer to the personal device 120, e.g., a unique identifier, e.g., a MAC address. In some embodiments, the origin of the data may refer to a user 105 associated with the data, either through ownership, use, or other relationship with the device, e.g., a username, a user's name, or a user's social security or other identifying number, or network address or identification.

Referring to FIGS. 1A-1D, data anonymization systems and methods are illustrated. Although these systems and methods are illustrated as part of computing device 130, this is merely for convenience of drawing. In an embodiment, one or more of data de-anonymization information storing module 135, data anonymizer module 134A, and data obscuring module 134B may be located within personal device 120. In an embodiment, these modules may interact directly with device memory 126. In an embodiment, as pictured in FIG. 1A, computing device 130 may include a data anonymizer module 134A that converts non-anonymous data 131B into anonymized data, in a process described in more detail with respect to FIGS. 1C and 1D. In an embodiment, depending on the type of anonymization, there may be additional data that can be used to return the anonymized data into non-anonymous data, e.g., a lookup table. In some such embodiments, the additional data, e.g., de-anonymization data, may be stored in data de-anonymization information storing module 135.

Referring again to FIGS. 1A-1D, in an embodiment, computing device 130 may include a data obscuring module 134B. For example, in an embodiment, data obscuring module 134B may obscure the non-anonymous data 131B, similarly to the data anonymizer module 134A. For example, in an embodiment, data obscuring module 134B may apply data masking. In an embodiment, data obscuring module 134B may obscure by addition, e.g., by adding false identification information to the true identification information, so that the false identification information may not be distinguished from the true identification information. Data de-anonymization information storing module 135, data anonymizer module 134A, and data obscuring module 134B may be absent in some embodiments.

Referring again to FIG. 1A, in an embodiment, computing device 130 may include service developer interface module 136. Service developer interface module 136 may communicate with service developer 160, e.g., via communication network 140. Specifically, in an embodiment, service developer interface module 136 may provide limited information regarding the acquired personal device data 131. In an embodiment, for example, service developer interface module 136 may provide information to service developer 160 regarding the type of data collected. In an embodiment, for example, service developer interface module 136 may provide information to service developer 160 regarding an aggregate synopsis of the data collected. In an embodiment, service developer 160 may receive such information and make a decision about what types of services to develop, e.g., using development decision module 162.

Referring again to FIG. 1A, in an embodiment, computing device 130 may include service provider interface module 138. In an embodiment, service provider interface module 138 may communicate with service provider 170, e.g., via communication network 140.

In an embodiment, service provider interface module 138 may include data rights management module 138A. In an embodiment, data rights management module 138A may keep track of which services have rights to which personal device data. For example, in an embodiment, service 172A may have rights to certain anonymous data 131A. For another example, in an embodiment, service 172B may have rights to data that has been processed through the data anonymizer 134A.

Referring again to FIG. 1A, in an embodiment, service provider interface module 138 may include service information module 138B. Service information module 138B may include a list of services that are provided from service provider 170, so that such information may be delivered to personal device 120, in an embodiment. In an embodiment, computing device 130 may present one or more of the services listed in service information module 138B to personal device 120, either upon request, or upon detecting that personal device 120 may be interested in one or more of the services.

Referring again to FIG. 1A, in an embodiment, service provider 170 may provide services to a personal device 120. In an embodiment, these services may be delivered to directly to personal device 120. In an embodiment, service provider 170 has limited or no communication with personal device 120, and communication is handled through an intermediary, e.g., computing device 130. In an embodiment, computing device 130 handles the delivery of services and data between service provider 170 and personal device 120 such that protected data 126A and protected component 128A are protected from service provider 170, but that service provider 170 can still provide services, e.g., service 172A and service 172B, to personal device 120. In an embodiment, service provider 170 includes a list of services management module 174 that maintains a list of services to present to computing device 130, e.g., to allow service information module 138B of computing device 130 to maintain information about various services.

In various embodiments, the communication network 140 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 140 may be wired, wireless, or a combination of wired and wireless networks. It is noted that “communication network” as used herein and in the drawings refers to one or more communication networks, which may or may not interact with each other and which, in some embodiments, may work in concert, wittingly or unwittingly, to facilitate communication between one or more entities.

Referring now to FIG. 1C, an embodiment may include a personal device 120A and a personal device 120B. Personal device 120A may generate non-anonymous data 144A, and personal device 120B may generate non-anonymous data 144B. Non anonymous data 144A and non-anonymous data 144B may be transmitted to computing device 130A, which may be a non-exclusive and non-limiting example of computing device 130. In an embodiment, computing device 130A may include a data anonymizer module 134A. In an embodiment, data anonymizer module 134A may include irreversible anonymizer module 137A, which generates anonymous data that is irreversible, e.g., in an example, the identifying data has been removed. In an embodiment, data anonymizer module 134A may include collective anonymizer module 137B, which may take the non-anonymous data 144A and the non-anonymous data 144B and create an aggregated, general anonymous data, as shown FIG. 1C. In an embodiment, data anonymizer module 134A may include reversible anonymizer module 137C, which may use a private lookup table 135A to convert the non-anonymous data into anonymous data. In an embodiment, that private lookup table 135A may be stored in the data-deanonymization information storing module 135.

Referring now to FIG. 1D, in an embodiment, a computing device 130B may have a data anonymizer 134A that may apply an anonymizing function 132A, as shown in FIG. 1D. For example, an anonymizing function may use a cryptographic method, a perturbation method, a DataFly algorithm, top-down specialization, and/or Mondarian multi-dimensional k-anonymity, as non-limiting and non-exclusive examples. In another embodiment, a data obscuring module 134B obscures the non-anonymous data. In an embodiment, the obscuring may be accomplished by adding similar-looking and plausible “false” data to the actual identifying data, so that later, the true data cannot be determined merely by looking at the data. In an embodiment, the anonymized data may be used by the service provider interface module 38 to give data to the service provider 170, either to carry out a portion of a service, or to determine which services may be useful to one or more personal devices 120.

The examples shown in FIGS. 1C and 1D are merely examples of how a data anonymizer might be implemented, and are not intended to be limiting or exclusive. There are many other techniques for anonymizing the data, some of which will be mentioned herein.

Referring now to FIG. 1E, FIG. 1E shows an embodiment of the invention focusing on a service provider 170 and a computing device 130C. Computing device 130C may receive data from one or more devices, and that data may be anonymized already, or may not be anonymized, or may already be obscured. In an embodiment, computing device 130C may generate obscured data from the data received from one or more devices, whether received directly from the one or more devices, or indirectly from another source. In an embodiment, Computing device 130C may obscure received data, even if the received data is already anonymized. In another embodiment, computing device 130C may not perform additional steps on previously anonymized or obscured data.

Referring again to FIG. 1E, in an embodiment, computing device 130C may request one or more services 190 that may be executed on one or more devices. The one or more services may be performed independently by the one or more devices, or may be performed with facilitation of one or more portions of the services by computing device 130C. Computing device 130C may request that service provider 170 provide one or more services that can be presented to the one or more devices. In an embodiment, computing device 130C may transmit obscured data 185 to service provider 170. This transmission may take place via any form of network, e.g., communication network 140 (not pictured in FIG. 1E). In an embodiment, service provider 170 may be integral with computing device 130C. In an embodiment, service provider 170 and computing device 130C may be under the control of a single entity.

Referring again to FIG. 1E, in an embodiment, service provider 170 may receive the obscured data 185. The obscured data 185 may be in any format, as described in several examples herein. The examples illustrated in FIG. 1E and in the following figures are intended for ease of understanding only, and should not be considered an exhaustive or an exclusive enumeration of ways that data may be obscured. For example, in an embodiment, irreversible anonymous data 185A may be obscured by deleting the device origin information from the data, such that the data cannot be recovered using the irreversible anonymous data 185A. In order to obtain the original device information that formed the irreversible anonymous data 185A, a copy of the original data may be retrieved. For example, in an embodiment, computing device 130C may store a separate copy of the data that resulted in the irreversible anonymous data 185A, with uniquely identifying device information present in the copy kept by computing device 130C.

In an embodiment, obscured data 185 may include reversible anonymous data 185B. Data 185B is not limited to a particular type of format, but a simple example is shown. In the example, the device identifiers of the one or more personal devices 120A and 120B, e.g., 00123 and 00124, are converted to new identifiers XYZ and YYZ (e.g., as shown in FIG. 1C), which, in an embodiment, may prevent service provider 170 from learning the identity of devices 00123 and 00124. In an embodiment, reversible anonymous data 185B may be converted into data that uniquely identifies one or more devices, through the providing of one or more algorithms, lookup tables, keys, encryption keys, hash functions, and the like.

In an embodiment, obscured data 185 may include general anonymous data 185C. In an embodiment, this type of data may include any format of aggregated data which gives information about one or more devices, but does not particularly identify the one or more devices that led to the aggregate information. For example, general anonymous data 185C may include such data as “thirty-five devices with more than twenty contacts in a contact list found,” or more specific data, such as “thirty-five smartphones, e.g., Apple iPhone 4S running iOS 6.0, with more than 2.0 gigabytes of space remaining, with more than twenty contacts in a contact list found.”

Referring again to FIG. 1E, in an embodiment, service provider 170 may receive obscured data 185, as shown in FIG. 1E. In an embodiment, service provider 170 may include an obscured data analyzer module 173. Obscured data analyzer module 173 may receive the obscured data 185 and use the obscured data 185 to determine one or more services or types of services that may be useful to the devices referenced in the obscured data 185. Obscured data analyzer module 173 may be completely automated, or may have some human intervention in the process. In an embodiment, obscured data analyzer 173 may obtain obscured data 185 from several different computing devices 130C, which may allow service provider 170 to provide one or more services more efficiently. In an embodiment, service provider 170 may include service management module 174. Service management module 174 may include existing service analyzing module 174A and new service generation module 174B. Existing service analyzing module 174A and new service generation module 174B may work together or separately, and with or without obscured data analyzer module 173, to determine if a service exists that meets the needs determined based on the received obscured data. If such a service does not exist, then new service generation module 174B may generate a new service, either by requesting from a third party, requesting human intervention, e.g., human programming of a new service, or may generate a new service automatically.

In an embodiment, service provider 170 may include a service transmission module 175, which may transmit one or more services 186 back to the computing device 130C, e.g., to service receiving module 138B, which, in an embodiment, may be a portion of service provider interface module 138. In various embodiments, once one or more actions are taken with respect to receiving the one or more services 186, deobscuring data 187, which may be data that can deobscure the obscured data 185, may be transmitted to the service provider 170, e.g., to data deobscuring module 176 of service provider 170. In an embodiment, deobscuring data 187 is combined with obscured data 185 to result in deobscured data. In another embodiment, deobscuring data 187 does not need to be combined with obscured data 185 in order to result in the deobscured data. In an embodiment, deobscuring data 187 may be transmitted upon receipt of one or more services 186. In another embodiment, one or more actions related to one or more services 186, e.g., proposing the one or more services to one or more devices, may be carried out prior to transmitting the deobscuring data 187. In an embodiment, if a particular number of users do not use one or more services 186, then computing device 130C may not transfer deobscuring data 187.

Referring now to FIG. 1F, FIG. 1F shows an embodiment of the invention as shown in exemplary embodiment 100″″. For example, FIG. 1F shows computing device 130D interacting with personal device 120. In an embodiment, computing device 130D receives device data 188 from personal device 120. Although FIG. 1F shows this transfer as coming directly from personal device 120, in an embodiment, computing device 130D may receive device data 188 from any source, including a third device, a communication network, a social networking site, a device manufacturer, and the like. In an embodiment, computing device 130D monitors one or more personal devices 120 for device data 188. In an embodiment, computing device 130D monitors one or more other sources for device data 188 regarding personal devices 120.

In an embodiment, device data 188 may include data that personal device 120 has collected. In an embodiment, the device data 188 may be modified to obscure an identity of the device 120 or a user of the device 120. In an embodiment, the device data 188 is not obscured. In an embodiment, device data 188 may be about data that is stored on device 120 or otherwise under the control of personal device 120, rather than being the actual data under the control of personal device 120. For example, as shown in FIG. 1F, personal device 120 may include protected data 126A, which, in an embodiment, may include the last thirty locations visited by personal device 120. In an embodiment, device data 188 may include the last thirty locations visited by personal device 120. In another embodiment, device data 188 may include an indication that personal device 120 has thirty device locations stored in its memory. In an embodiment, device data 188 may include an indication that personal device 120 has thirty device locations stored in its memory, and 20 of those locations are locations for which an interest has been expressed by an entity in communication with computing device 130D.

Referring again to FIG. 1F, in an embodiment, computing device 130D may include personal device interface module 132. Personal device interface module 132 may include data value monitoring module 132A. In an embodiment, data value monitoring module 132A may receive information regarding which types of data are valuable (e.g., location data, or location data indicating that a device is inside Times Square on New Years' Eve, and the like), and may monitor one or more devices and other locations for one or more indications that a personal device 120 has data estimated to be valuable, and whether that data is protected. In an embodiment, personal device interface module may include device information receiving module 132B configured to receive device data 188. Device data 188 may have any number of formats, as described above, and as shown by way of non-limiting example in the examples given further herein.

Referring again to FIG. 1F, in an embodiment, computing device 130D may include device monitoring module 132C. In an embodiment, device monitoring module 132C may monitor one or more personal devices 120 through any monitoring technique. In an embodiment, device monitoring module 132C may include software, hardware, or firmware associated with personal device 120, that may be configured to report back to device monitoring module 132C at particular intervals. In an embodiment, device monitoring module 132C may monitor personal device 120 through one or more communication networks 140 (not pictured), and may communicate directly with personal device 120. In an embodiment, device monitoring module 132C may monitor personal device 120 through indirect means, e.g., through other devices or systems that may be used by personal device 120.

Referring again to FIG. 1F, in an embodiment, personal device interface module 132 may include service offering module 132D. For example, as described previously, computing device 130D may acquire one or more services. These services may be presented to personal device 120, either for presentation to a user, or for an automated decision regarding whether to accept the services. In an embodiment, the one or more services 188 may require access to protected data, e.g., protected data 126A of the personal device 120, or one or more protected components, e.g., protected component 128A of personal device 120, or both. In an embodiment, computing device 130D may facilitate the presentation of the one or more services to a user 105 of the personal device 120, via the personal device 120.

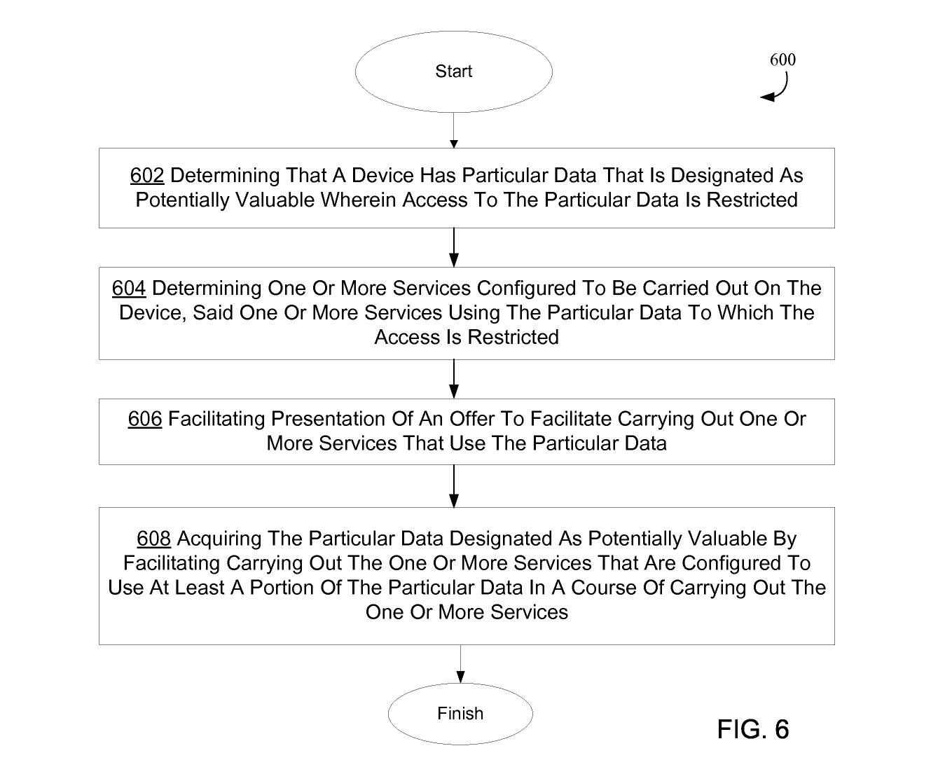

Referring again to FIG. 1B, FIG. 1B shows a more detailed description of computing device 130. In an embodiment, computing device 130 may include a processor 110. Processor 110 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 110 may be a server. In some embodiments, processor 110 may be a distributed-core processor. Although processor 110 is as a single processor that is part of a single computing device 130, processor 110 may be multiple processors distributed over one or many computing devices 130, which may or may not be configured to operate together. Processor 110 is illustrated as being configured to execute computer readable instructions in order to execute one or more operations described above, and as illustrated in FIGS. 6, 7A-7F, 8A-8B, 9A-9C, and 10A-10D. In some embodiments, processor 110 is designed to be configured to operate as processing module 150, which may include one or more of particular data indicated as potentially valuable data presence on a device with restricted access finding module 152, one or more device-based services configured to utilize particular data indicated as potentially valuable determining module 154, presentation of an offer of one or more device-based services using the particular data to the device facilitating module 156, and access to particular data indicated as potentially valuable obtaining by facilitating execution of the one or more determined device-based services module 158.

In an embodiment, computing device 130 may include a device memory 116. In some embodiments, memory 116 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 116 may be located at a single network site. In some embodiments, memory 116 may be located at multiple network sites, including sites that are distant from each other.

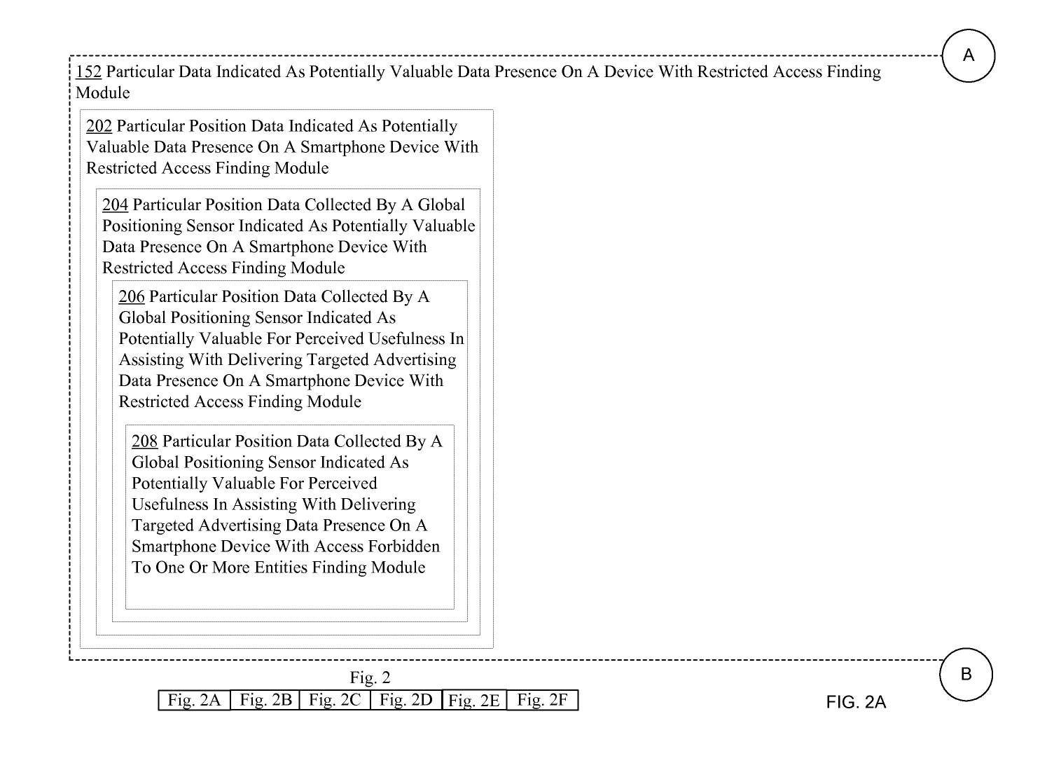

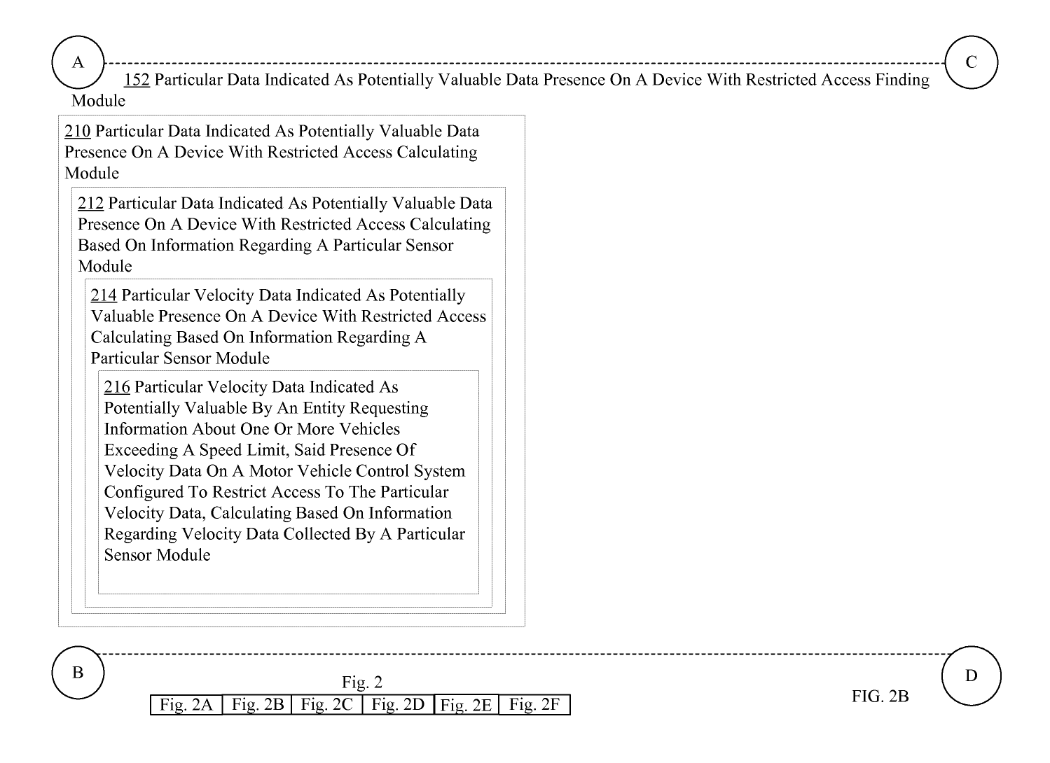

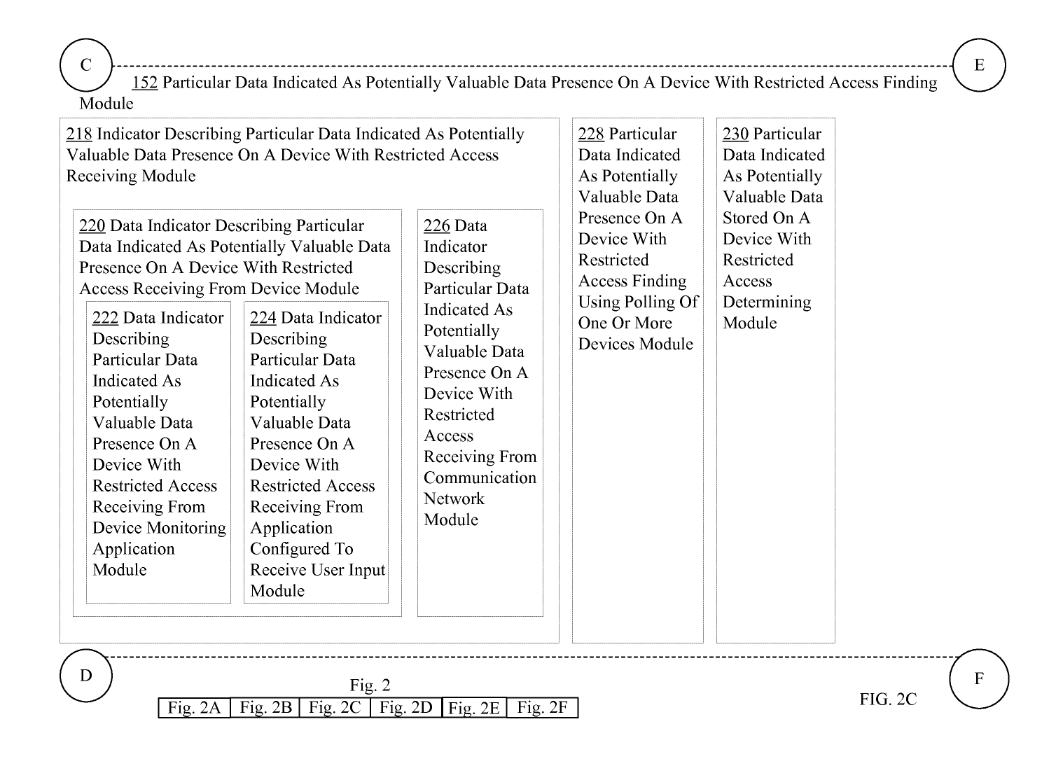

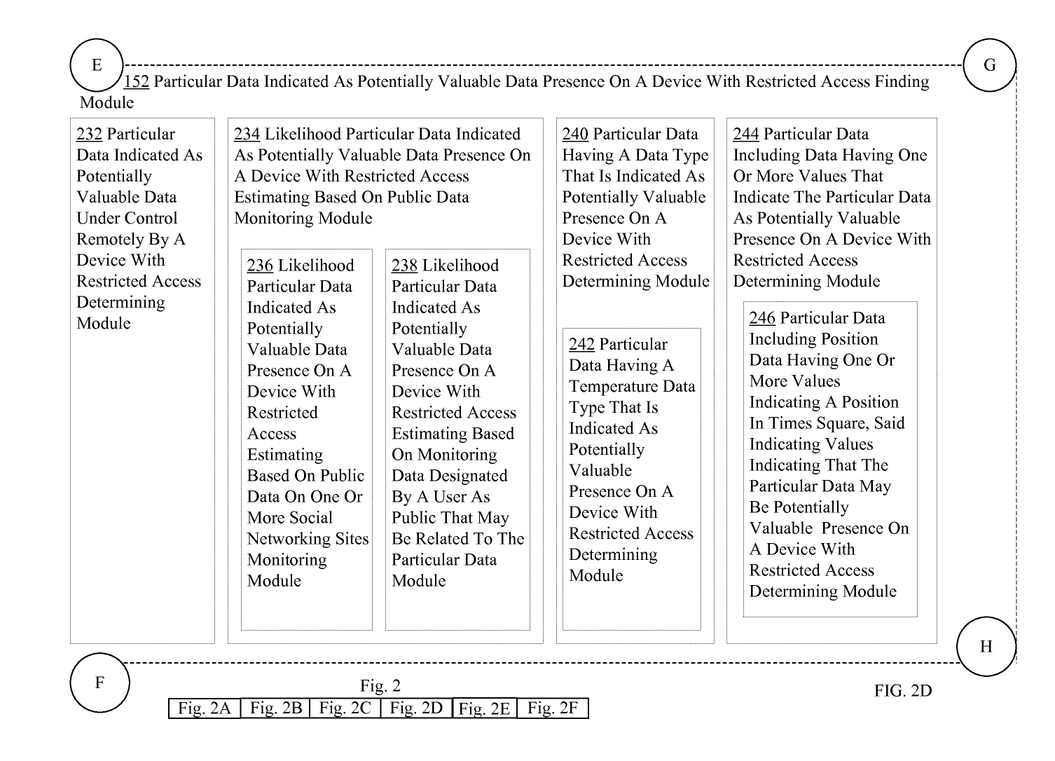

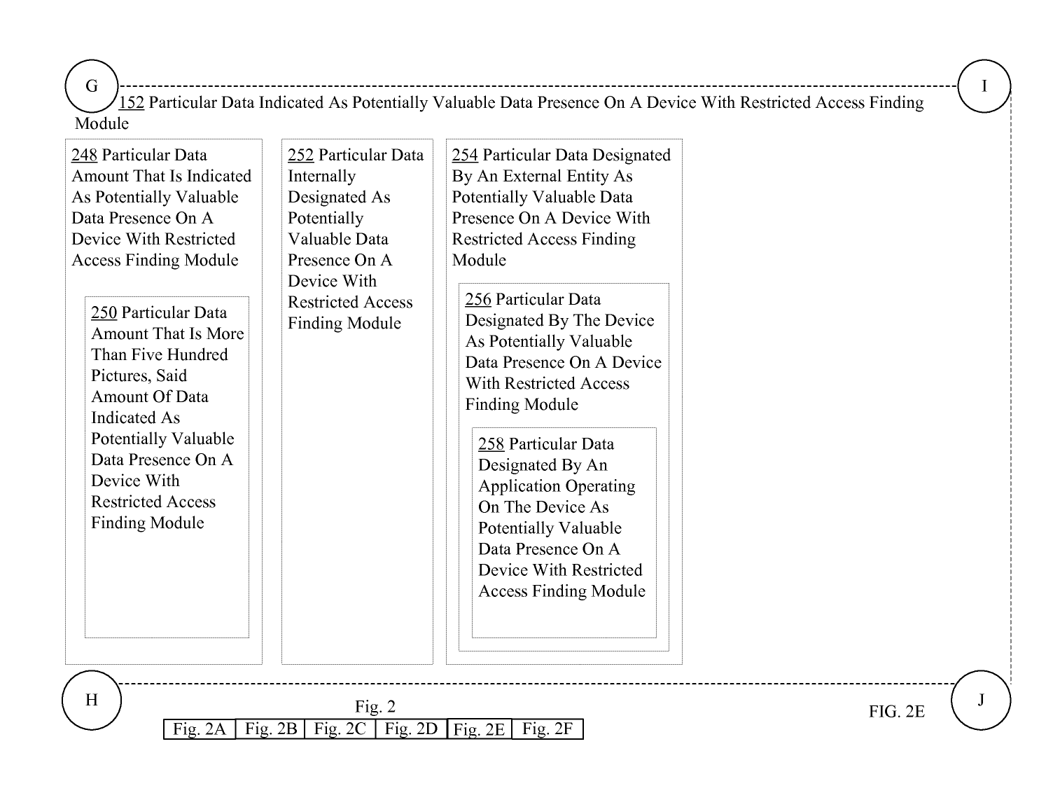

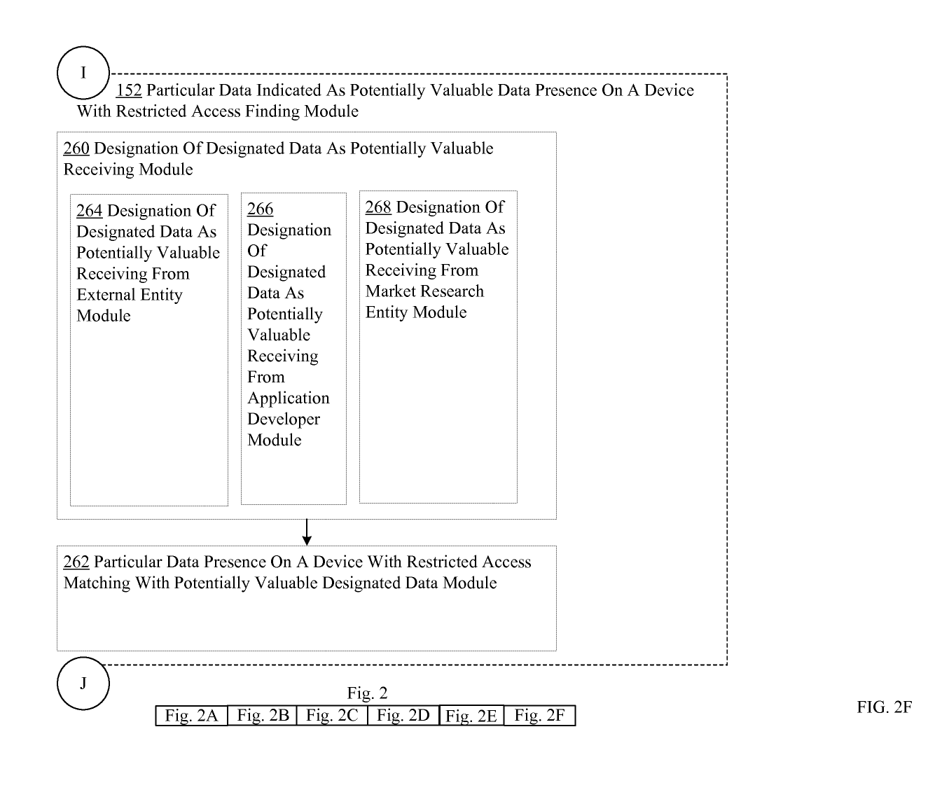

Referring now to FIG. 2, FIG. 2 illustrates an exemplary implementation of the particular data indicated as potentially valuable data presence on a device with restricted access finding module 152. As illustrated in FIG. 2, the particular data indicated as potentially valuable data presence on a device with restricted access finding module may include one or more sub-logic modules in various alternative implementations and embodiments. For example, as shown in FIG. 2, e.g., FIG. 2A, in some embodiments, module 152 may include particular position data indicated as potentially valuable data presence on a smartphone device with restricted access finding module 202. In some embodiments, module 202 may include particular position data collected by a global positioning sensor indicated as potentially valuable data presence on a smartphone device with restricted access finding module 204. In some embodiments, module 204 may include particular position data collected by a global positioning sensor indicated as potentially valuable for perceived usefulness in assisting with delivering targeted advertising data presence on a smartphone device with restricted access finding module 206. In some embodiments, module 206 may include particular position data collected by a global positioning sensor indicated as potentially valuable for perceived usefulness in assisting with delivering targeted advertising data presence on a smartphone device with access forbidden to one or more entities finding module 208.

Referring again to FIG. 2, e.g., FIG. 2B, in some embodiments, module 152 may include particular data indicated as potentially valuable data presence on a device with restricted access calculating module 210. In some embodiments, module 210 may include particular data indicated as potentially valuable data presence on a device with restricted access calculating based on information regarding a particular sensor module 212. In some embodiments, module 212 may include particular velocity data indicated as potentially valuable presence on a device with restricted access calculating based on information regarding a particular sensor module 214. In some embodiments, module 214 may include one or more of particular velocity data indicated as potentially valuable by an entity requesting information about one or more vehicles exceeding a speed limit, said presence of velocity data on a motor vehicle control system configured to restrict access to the particular velocity data, calculating based on information regarding velocity data collected by a particular sensor module 216.

Referring again to FIG. 2, e.g., FIG. 2C, as described above, in some embodiments, module 152 may include one or more of indicator describing particular data indicated as potentially valuable data presence on a device with restricted access receiving module 218, particular data indicated as potentially valuable data presence on a device with restricted access finding using polling of one or more devices module 228, and particular data indicated as potentially valuable data stored on a device with restricted access determining module 230. In some embodiments, module 218 may include one or more of data indicator describing particular data indicated as potentially valuable data presence on a device with restricted access receiving from device module 220 and data indicator describing particular data indicated as potentially valuable data presence on a device with restricted access receiving from communication network module 226. In some embodiments, module 220 may include one or more of data indicator describing particular data indicated as potentially valuable data presence on a device with restricted access receiving from device monitoring application module 222 and data indicator describing particular data indicated as potentially valuable data presence on a device with restricted access receiving from application configured to receive user input module 224.

Referring again to FIG. 2, e.g., FIG. 2D, in some embodiments, module 152 may include one or more of particular data indicated as potentially valuable data under control remotely by a device with restricted access determining module 232, likelihood particular data indicated as potentially valuable data presence on a device with restricted access estimating based on public data monitoring module 234, particular data having a data type that is indicated as potentially valuable presence on a device with restricted access determining module 240, and particular data including data having one or more values that indicate the particular data as potentially valuable presence on a device with restricted access determining module 244. In some embodiments, module 234 may include one or more of likelihood particular data indicated as potentially valuable data presence on a device with restricted access estimating based on public data on one or more social networking sites monitoring module 236 and likelihood particular data indicated as potentially valuable data presence on a device with restricted access estimating based on monitoring data designated by a user as public that may be related to the particular data module 238. In some embodiments, module 240 may include particular data having a temperature data type that is indicated as potentially valuable presence on a device with restricted access determining module 242. In some embodiments, module 244 may include particular data including position data having one or more values indicating a position in times square, said indicating values indicating that the particular data may be potentially valuable presence on a device with restricted access determining module 246.

Referring again to FIG. 2, e.g., FIG. 2E, in some embodiments, module 152 may include one or more of particular data amount that is indicated as potentially valuable data presence on a device with restricted access finding module 248, particular data internally designated as potentially valuable data presence on a device with restricted access finding module 252, and particular data designated by an external entity as potentially valuable data presence on a device with restricted access finding module 254. In some embodiments, module 248 may include particular data amount that is more than five hundred pictures, said amount of data indicated as potentially valuable data presence on a device with restricted access finding module 250. In some embodiments, module 254 may include particular data designated by the device as potentially valuable data presence on a device with restricted access finding module 256. In some embodiments, module 256 may include particular data designated by an application operating on the device as potentially valuable data presence on a device with restricted access finding module 258.

Referring again to FIG. 2, e.g., FIG. 2F, in some embodiments, module 152 may include one or more of designation of designated data as potentially valuable receiving module 260 and particular data presence on a device with restricted access matching with potentially valuable designated data module 262. In some embodiments, module 260 may include one or more of designation of designated data as potentially valuable receiving from external entity module 264, designation of designated data as potentially valuable receiving from application developer module 266, and designation of designated data as potentially valuable receiving from market research entity module 268.

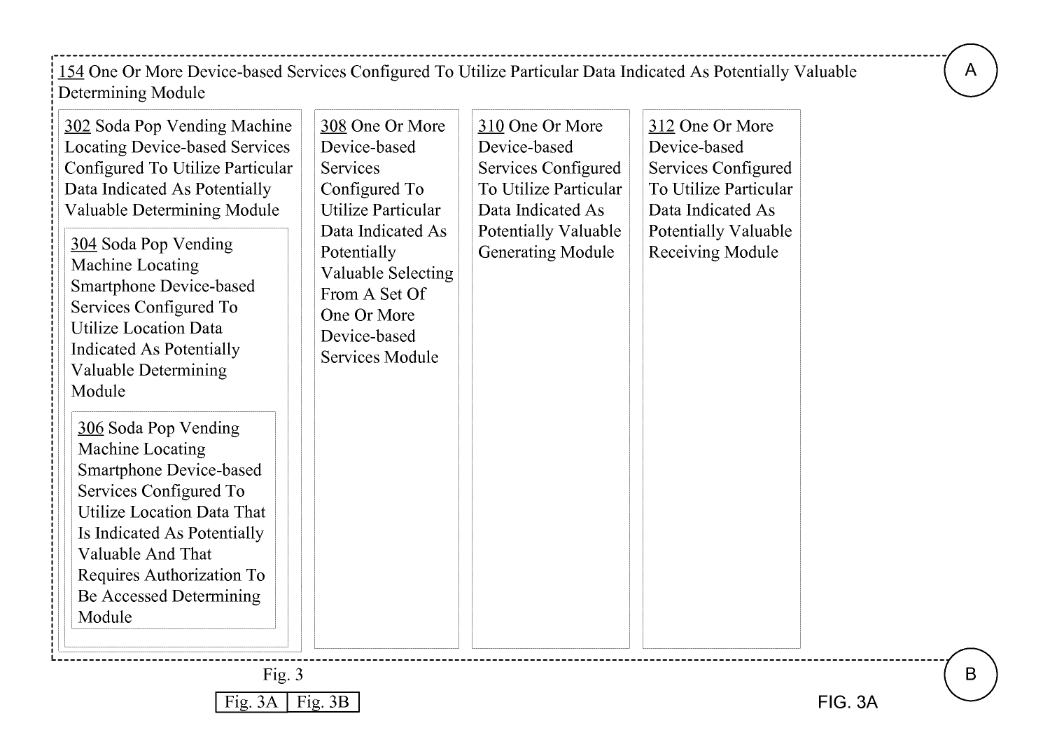

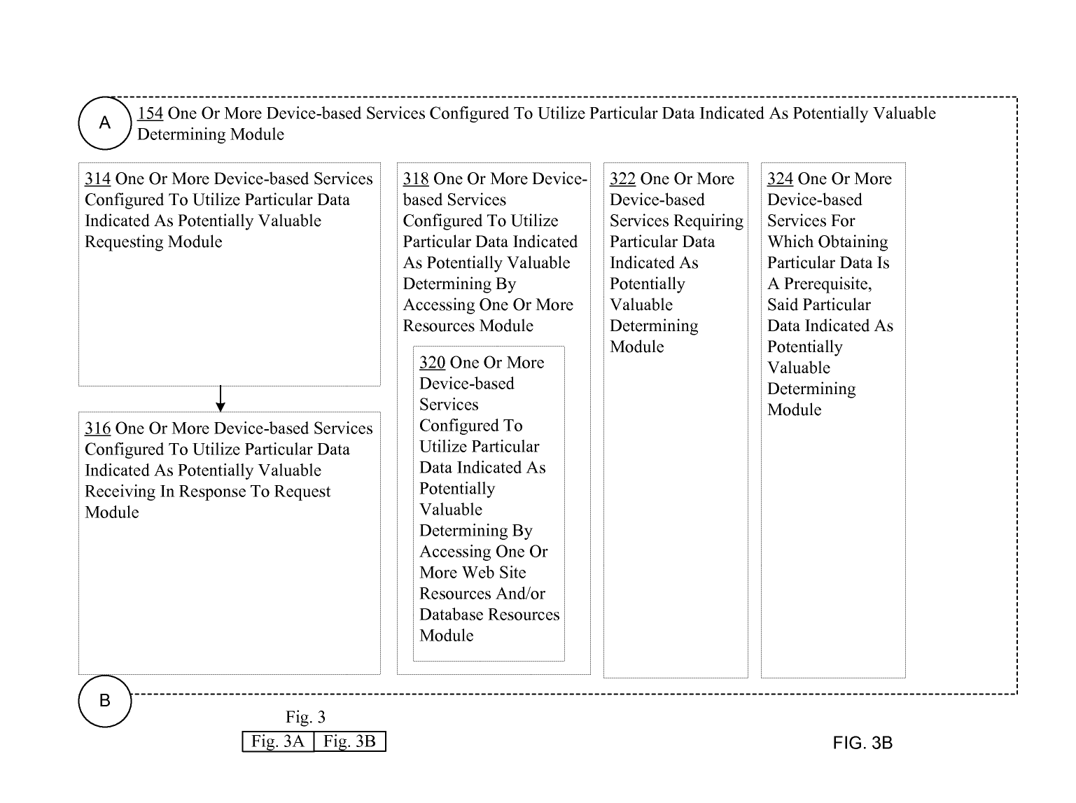

Referring now to FIG. 3, FIG. 3 illustrates an exemplary implementation of one or more device-based services configured to utilize particular data indicated as potentially valuable determining module 154. As illustrated in FIG. 3, the one or more device-based services configured to utilize particular data indicated as potentially valuable determining module 154 may include one or more sub-logic modules in various alternative implementations and embodiments. For example, as shown in FIG. 3 (e.g., FIG. 3A), in some embodiments, module 154 may include one or more of soda pop vending machine locating device-based services configured to utilize particular data indicated as potentially valuable determining module 302, one or more device-based services configured to utilize particular data indicated as potentially valuable selecting from a set of one or more device-based services module 308, one or more device-based services configured to utilize particular data indicated as potentially valuable generating module 310, and one or more device-based services configured to utilize particular data indicated as potentially valuable receiving module 312. In some embodiments, module 302 may include soda pop vending machine locating smartphone device-based services configured to utilize location data indicated as potentially valuable determining module 304. In some embodiments, module 304 may include soda pop vending machine locating smartphone device-based services configured to utilize location data that is indicated as potentially valuable and that requires authorization to be accessed determining module 306.

Referring again to FIG. 3, e.g., FIG. 3B, as described above, in some embodiments, module 154 may include one or more of one or more device-based services configured to utilize particular data indicated as potentially valuable requesting module 314, one or more device-based services configured to utilize particular data indicated as potentially valuable receiving in response to request module 316, one or more device-based services configured to utilize particular data indicated as potentially valuable determining by accessing one or more resources module 318 (e.g., which, in some embodiments, may include one or more device-based services configured to utilize particular data indicated as potentially valuable determining by accessing one or more web site resources and/or database resources module 320), one or more device-based services requiring particular data indicated as potentially valuable determining module 322, and one or more device-based services for which obtaining particular data is a prerequisite, said particular data indicated as potentially valuable determining module 324.

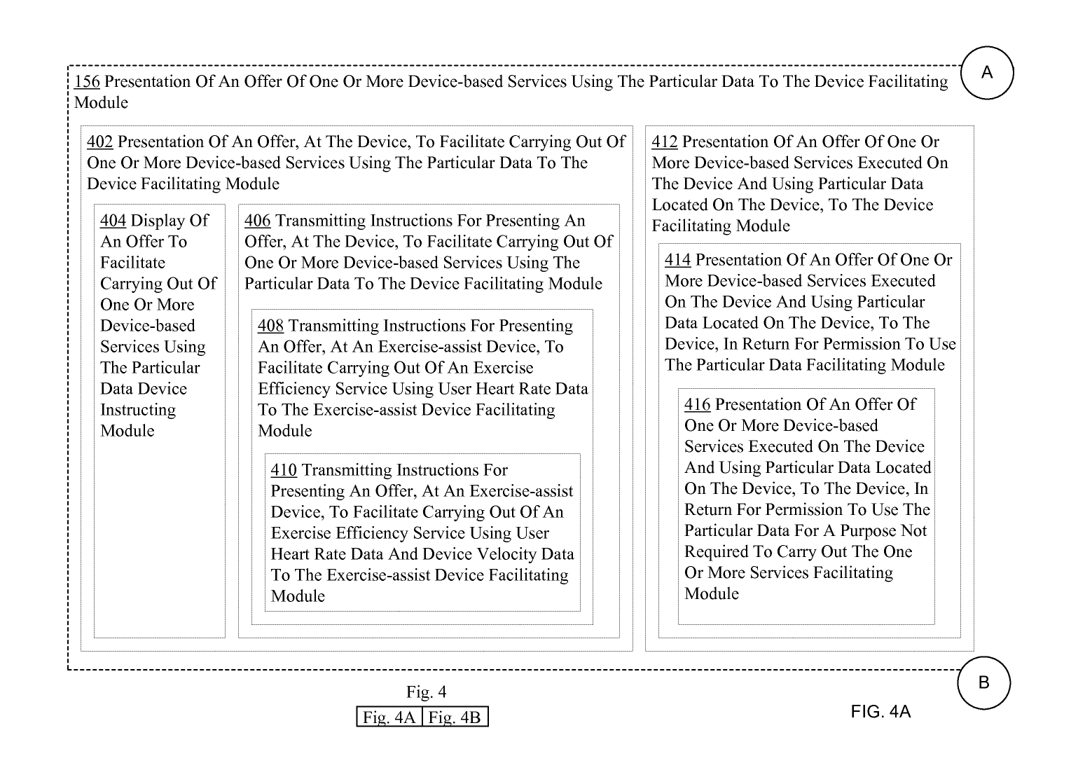

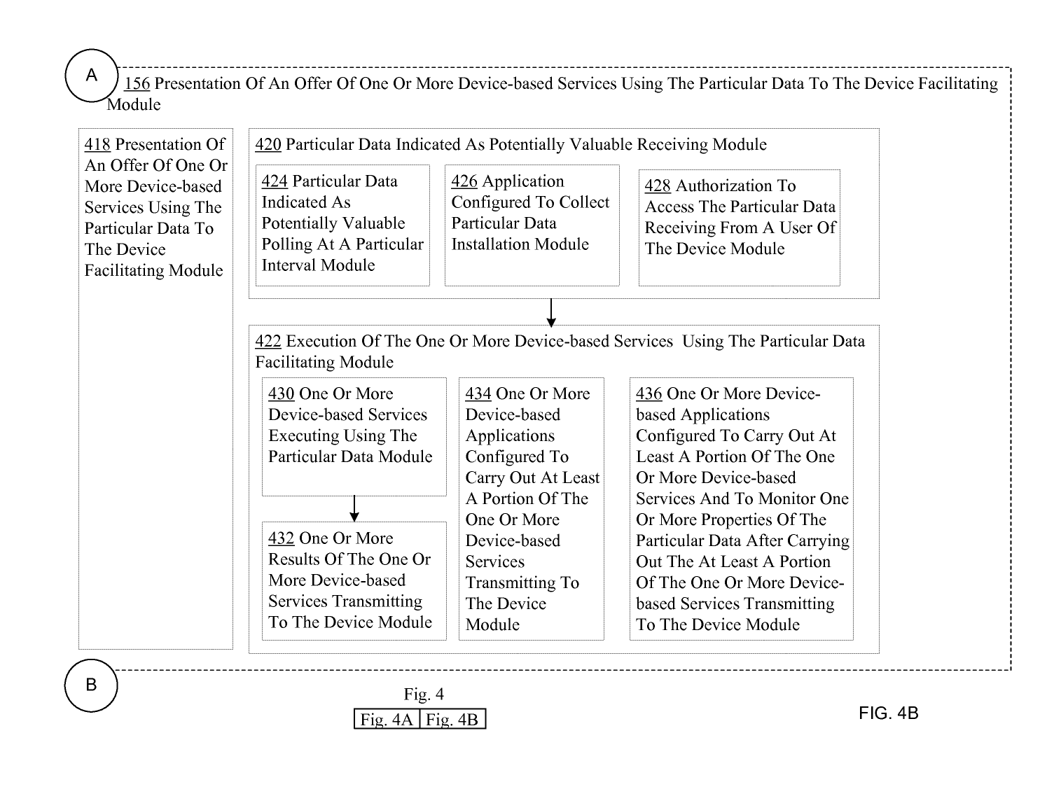

Referring now to FIG. 4, FIG. 4 illustrates an exemplary implementation of presentation of an offer of one or more device-based services using the particular data to the device facilitating module 156. As illustrated in FIG. 4, the presentation of an offer of one or more device-based services using the particular data to the device facilitating module 156 may include one or more sub-logic modules in various alternative implementations and embodiments. For example, as shown in FIG. 4, e.g., FIG. 4A, in some embodiments, module 156 may include one or more of presentation of an offer, at the device, to facilitate carrying out of one or more device-based services using the particular data to the device facilitating module 402 and presentation of an offer of one or more device-based services executed on the device and using particular data located on the device, to the device facilitating module 412. In some embodiments, module 402 may include one or more of display of an offer to facilitate carrying out of one or more device-based services using the particular data device instructing module 404 and transmitting instructions for presenting an offer, at the device, to facilitate carrying out of one or more device-based services using the particular data to the device facilitating module 406. In some embodiments, module 406 may include transmitting instructions for presenting an offer, at an exercise-assist device, to facilitate carrying out of an exercise efficiency service using user heart rate data to the exercise-assist device facilitating module 408. In some embodiments, module 408 may include transmitting instructions for presenting an offer, at an exercise-assist device, to facilitate carrying out of an exercise efficiency service using user heart rate data and device velocity data to the exercise-assist device facilitating module 410. In some embodiments, module 412 may include presentation of an offer of one or more device-based services executed on the device and using particular data located on the device, to the device, in return for permission to use the particular data facilitating module 414. In some embodiments, module 414 may include presentation of an offer of one or more device-based services executed on the device and using particular data located on the device, to the device, in return for permission to use the particular data for a purpose not required to carry out the one or more services facilitating module 416.

Referring again to FIG. 4, e.g., FIG. 4B, in some embodiments, module 156 may include one or more of presentation of an offer of one or more device-based services using the particular data to the device facilitating module 418, particular data indicated as potentially valuable receiving module 420, and execution of the one or more device-based services using the particular data facilitating module 422. In some embodiments, module 420 may include one or more of particular data indicated as potentially valuable polling at a particular interval module 424, application configured to collect particular data installation module 426, and authorization to access the particular data receiving from a user of the device module 428. In some embodiments, module 422 may include one or more of one or more device-based services executing using the particular data module 430, one or more results of the one or more device-based services transmitting to the device module 432, one or more device-based applications configured to carry out at least a portion of the one or more device-based services transmitting to the device module 434, and one or more device-based applications configured to carry out at least a portion of the one or more device-based services and to monitor one or more properties of the particular data after carrying out the at least a portion of the one or more device-based services transmitting to the device module 436.

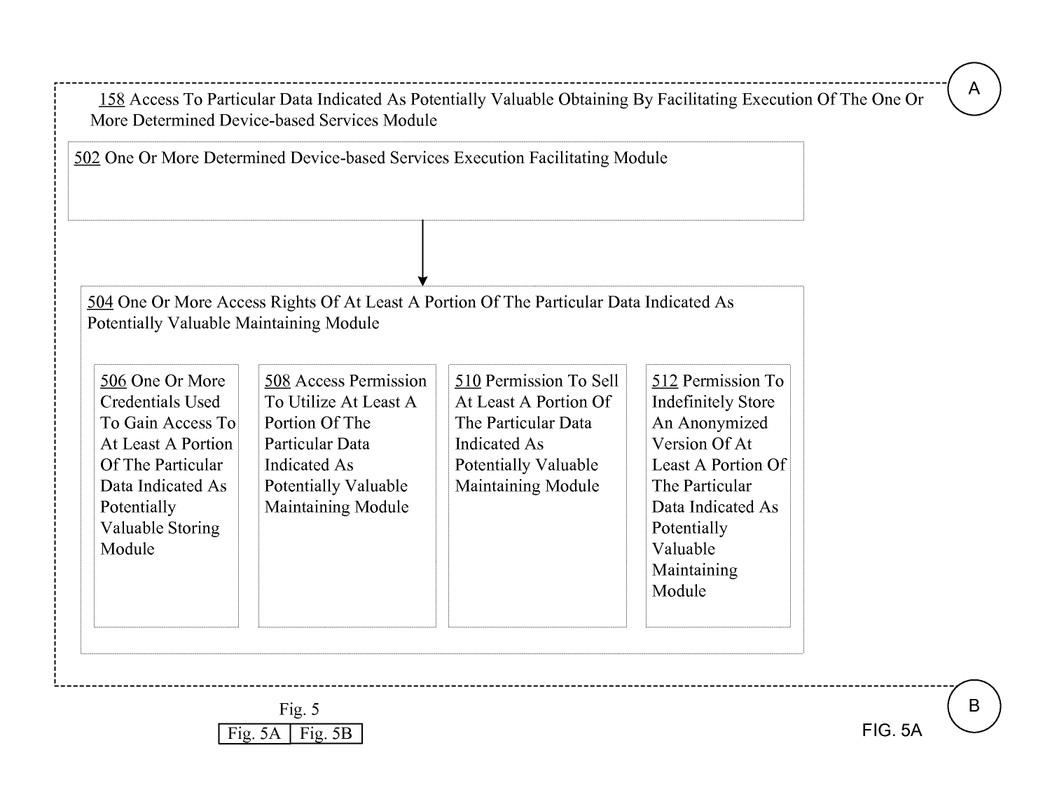

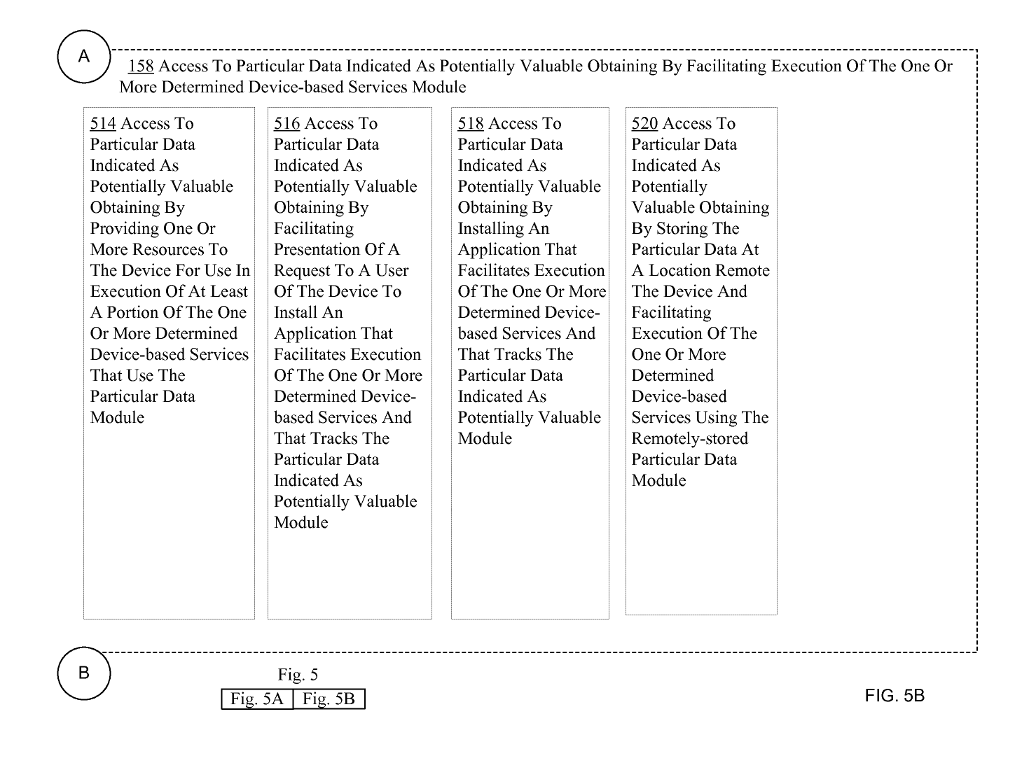

Referring now to FIG. 5, FIG. 5 illustrates an exemplary implementation of one or more device-based services configured to utilize particular data indicated as potentially valuable determining module 158. As illustrated in FIG. 5, the one or more device-based services configured to utilize particular data indicated as potentially valuable determining module 158 may include one or more sub-logic modules in various alternative implementations and embodiments. For example, as shown in FIG. 5, e.g., FIG. 5A, in some embodiments, module 158 may include one or more of one or more determined device-based services execution facilitating module 502 and one or more access rights of at least a portion of the particular data indicated as potentially valuable maintaining module 504. In some embodiments, module 504 may include one or more of one or more credentials used to gain access to at least a portion of the particular data indicated as potentially valuable storing module 506, access permission to utilize at least a portion of the particular data indicated as potentially valuable maintaining module 508, permission to sell at least a portion of the particular data indicated as potentially valuable maintaining module 510, and permission to indefinitely store an anonymized version of at least a portion of the particular data indicated as potentially valuable maintaining module 512.

Referring again to FIG. 5, e.g., FIG. 5B, in some embodiments, module 158 may include one or more of access to particular data indicated as potentially valuable obtaining by providing one or more resources to the device for use in execution of at least a portion of the one or more determined device-based services that use the particular data module 514, access to particular data indicated as potentially valuable obtaining by facilitating presentation of a request to a user of the device to install an application that facilitates execution of the one or more determined device-based services and that tracks the particular data indicated as potentially valuable module 516, access to particular data indicated as potentially valuable obtaining by installing an application that facilitates execution of the one or more determined device-based services and that tracks the particular data indicated as potentially valuable module 518, and access to particular data indicated as potentially valuable obtaining by storing the particular data at a location remote the device and facilitating execution of the one or more determined device-based services using the remotely-stored particular data module 520.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 6 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 6-10 as well as the other operations to be described herein may be performed by at least one of a machine, an article of manufacture, or a composition of matter.

The following examples are provided merely as illustrations of how various embodiments may be implemented. None of the following examples are intended to be limiting, and all of the examples listed herein may be combined with portions of other examples listed herein, to the extent such combinations are not logically inconsistent. Because of space limitations, each example is not written out each time it is possible to implement that example. Therefore, unless explicitly otherwise stated, each example should be understood to encompass every other example listed both before and after the instant example, and can be combined with any or all portions of other examples. Each example is not intended to be limited to a single claim or set of claims, but is rather exemplary of how one or more embodiments may be carried out. Nothing in the following should be interpreted as limiting any claim or enumerating an exhaustive list of how one or more claimed embodiments can be carried out.

Referring now to FIG. 6, FIG. 6 shows operation 600, which may include operation 602 depicting determining that a device has particular data that is designated as potentially valuable wherein access to the particular data is restricted. For example, FIG. 1, e.g., FIG. 1B, shows particular data indicated as potentially valuable data presence on a device with restricted access finding module 152 determining (e.g., receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds) that a device (e.g., a cellular phone, smart phone, IP phone, VOIP phone, handset, microphone, camera (e.g., video camera, still camera, digital camera, and the like), headphone, earpiece, screen, monitor, television, game system, receiver (e.g., an audio/visual receiver), media player (e.g., DVD player, Blu-ray player, CD player, MP3 player, cassette tape player), tablet device, netbook computer, notebook computer, router, wireless router, bridge, network equipment, server, desktop computer, personal computer, personal computer component (e.g., RAM, hard drive, video card, and the like), personal navigation system, vehicle navigation system, motor vehicle, motor vehicle stereo, motor vehicle control system, motor vehicle communication system (e.g., OnStar), appliance, security system (e.g., a home security system), electronic safety device (e.g., an electronic safe, a door security system, a door locking system), stereo system, speaker, remote control (e.g., a universal remote control, or a device remote control), radio, two-way radio, walkie-talkie, ham radio, a metal detector, a radar detector, a weather station, a robot (e.g., a Roomba), a vacuum cleaner, and the like) has particular data (e.g., any data, regardless of specificity) that is designated (e.g., marked, indicated, keyed, identified, tagged, indexed, categorized, or otherwise mentioned, whether in the data or external to the data, e.g., in a separate table, index, or other data structure) as potentially valuable (e.g., has some utility to one or more entities, whether human or automated, whether directly or indirectly, whether for use, sale, distribution, analysis, experimentation, observation, and the like), wherein access to the particular data is restricted (e.g., one or more entities, or portions of entities, including programs, hardware, software, users, components, data transmissions, communications, and the like), whether internal or external to the device, has a limitation about a manner in which they use the data, including, but not limited to, limitations on reading the data, copying the data, modifying the data, erasing the data, supplementing the data, distributing the data, moving the data, transferring the data, transmitting the data, receiving the data, and the like).

Referring again to FIG. 6, operation 600 may include operation 604 depicting determining one or more services configured to be carried out on the device, said one or more services using the particular data to which the access is restricted. For example, FIG. 1, e.g., FIG. 1B, shows one or more device-based services configured to utilize particular data indicated as potentially valuable determining module 154 determining (e.g., acquiring, obtaining, receiving, calculating, selecting from a list or other data structure, receiving, retrieving, or receiving information regarding, performing calculations to find out, retrieving data that indicates, receiving notification, receiving information that leads to an inference, whether by human or automated process, or being party to any action or transaction that results in informing, inferring, or deducting, including but not limited to circumstances without absolute certainty, including more-likely-than-not and/or other thresholds regarding whether the service is configured to be carried out on the device) one or more services (e.g., any task, or any portion of any task, or any combination of tasks, that can be carried out by a device, or by a device in communication with another device, which may include human interaction, or may not include human interaction, and which may require one or more resources, either locally to the device, or remotely from the device, and which may include one or more of hardware, software, firmware, data stored in or manipulated by any component, module, part, or portion of the device, including, but not limited to, hardware, software, applications, Application Programming Interfaces (“APIs”), one or more virtual machines, one or more Dynamically Loaded Libraries (“DLLs”), one or more relational databases, one or more GUI frameworks, one or more COM structured storages, or any portion of any other device that is under control of a device, e.g., a cloud resource, and the like) configured to be (e.g., the one or more services are designed to be carried out, or designed in a manner that makes the one or more services capable of being carried out) carried out (e.g., executed, performed, take a step or measure toward, schedule the performance of, instruct an entity to perform, and the like, including one or more portions of the service that are smaller than the service itself, including, but not limited to, data transmission and manipulation, and user interface handling, for example) on (e.g., in this context, on means that the device plays some role in facilitating the carrying out of the device, regardless of whether the device actually performs any of the steps of carrying out, or merely supplies one or more resources, data, or instructions that are used to carry out) the device (e.g., including, but not limited to, the list of devices set forth previously).

Referring again to FIG. 5, operation 600 may include operation 606 depicting facilitating presentation of an offer to facilitate carrying out one or more services that use the particular data. For example. FIG. 1, e.g., FIG. 1B, shows presentation of an offer of one or more device-based services using the particular data to the device facilitating module 156 facilitating (e.g., performing one or more actions that assist in the execution or completion of) presentation (e.g., show, through any combination of visual and non-visual interfaces) of an offer (e.g., a presentation to a potential recipient for which the recipient is free to accept or reject, e.g., which may be in the form of, for example “this is a service we are willing to provide, are you interested,” or any variant of that) to facilitate (e.g., perform one or more actions that assist in the execution or completion of) carrying out one or more services (e.g., any task, or any portion of any task, or any combination of tasks, that can be carried out by a device, or by a device in communication with another device, which may include human interaction, or may not include human interaction, and which may require one or more resources, either locally to the device, or remotely from the device, and which may include one or more of hardware, software, firmware, data stored in or manipulated by any component, module, part, or portion of the device, including, but not limited to, hardware, software, applications, Application Programming Interfaces (“APIs”), one or more virtual machines, one or more Dynamically Loaded Libraries (“DLLs”), one or more relational databases, one or more GUI frameworks, one or more COM structured storages, or any portion of any other device that is under control of a device, e.g., a cloud resource, and the like) that use (e.g., read, modify, observe, or perform any action on any part of, regardless of whether said action modifies the data) the particular data (e.g., any data, regardless of specificity).

Referring again to FIG. 5, operation 600 may include operation 608 depicting acquiring the particular data designated as potentially valuable by facilitating carrying out the one or more services that are configured to use at least a portion of the particular data in a course of carrying out the one or more services. For example. FIG. 1, e.g., FIG. 1B, shows access to particular data indicated as potentially valuable obtaining by facilitating execution of the one or more determined device-based services module 158 acquiring (e.g., receiving, retrieving, picking up, creating, generating, intercepting, reading, hearing, detecting, and the like) the particular data designated as potentially valuable by facilitating (e.g., taking one or more actions that, whether directly or indirectly, are intended to assist in the completion, execution, or carrying out of at least a portion of) carrying out (e.g., execute, intend to execute, or begin executing, or taking one or more steps to allow the execution of) the one or more services that are configured to use at least a portion of the particular data in a course (e.g., prior to completion of) of carrying out the one or more services.

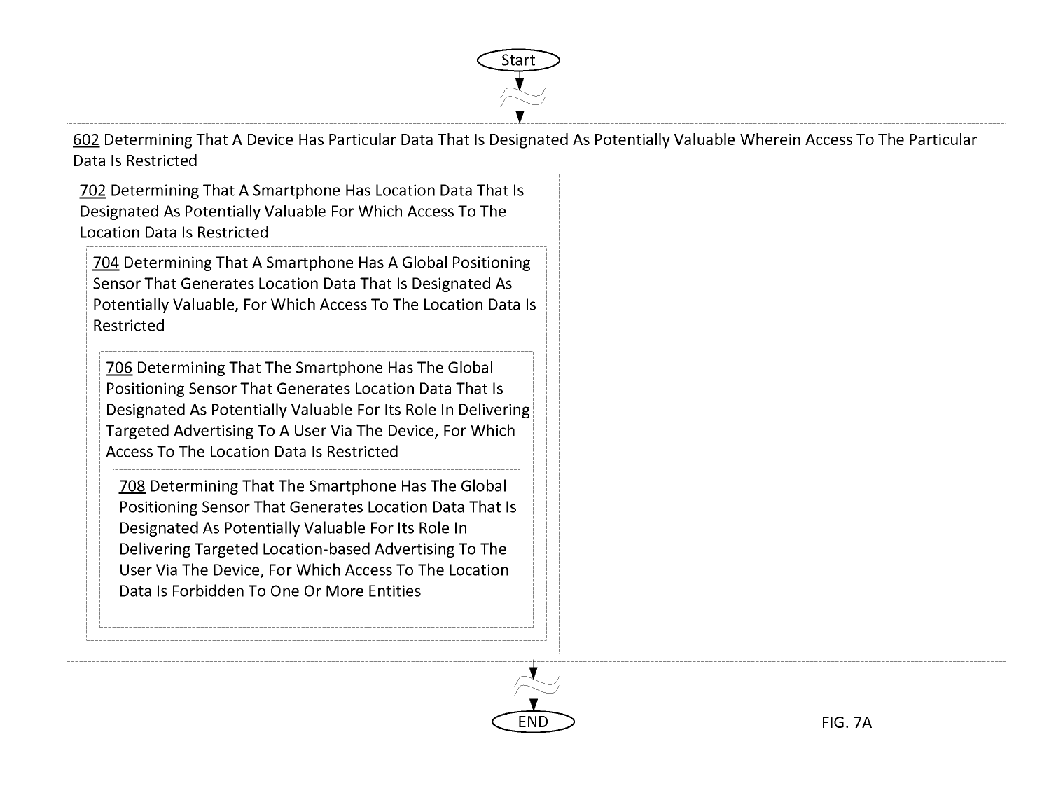

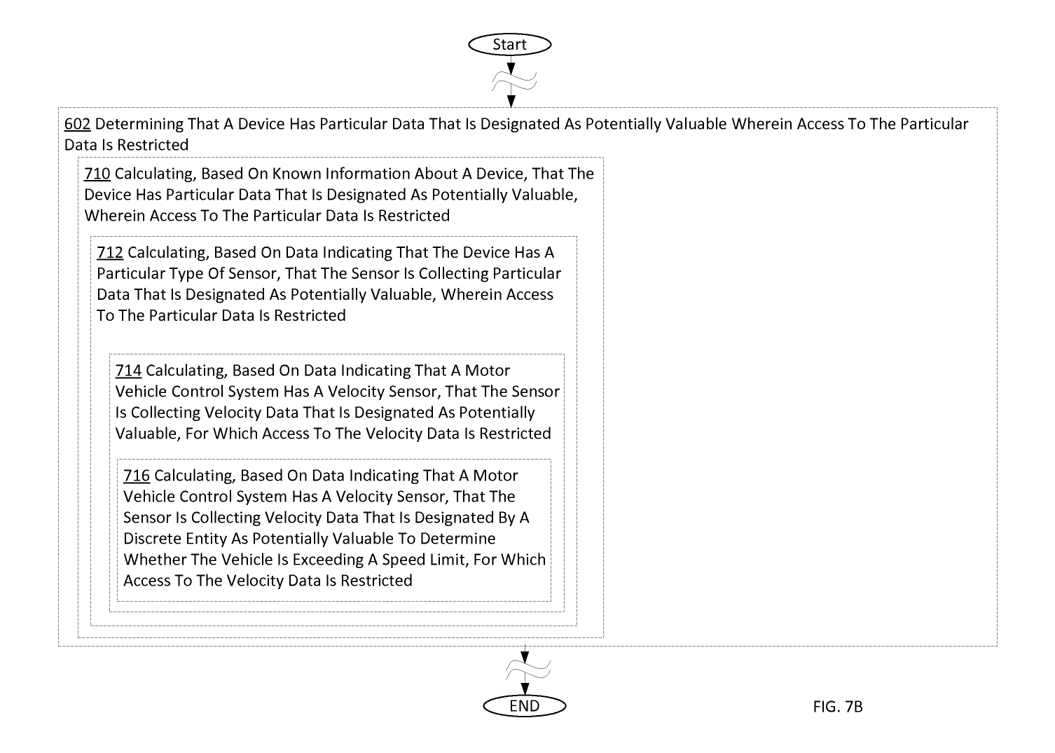

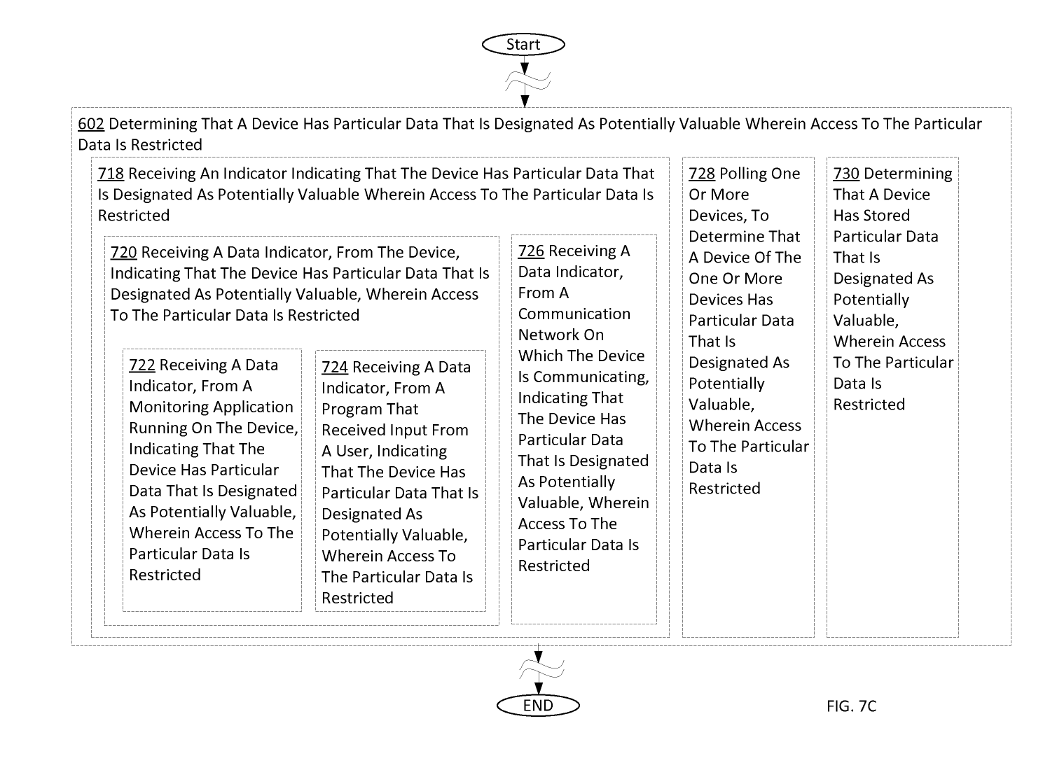

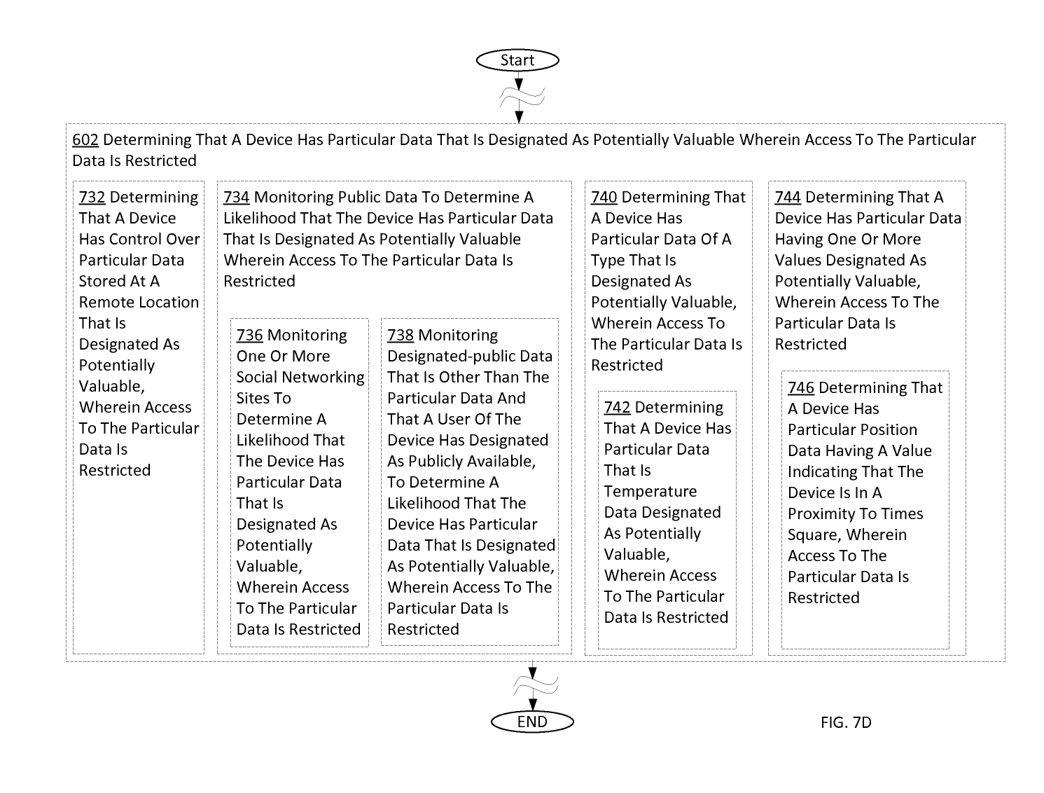

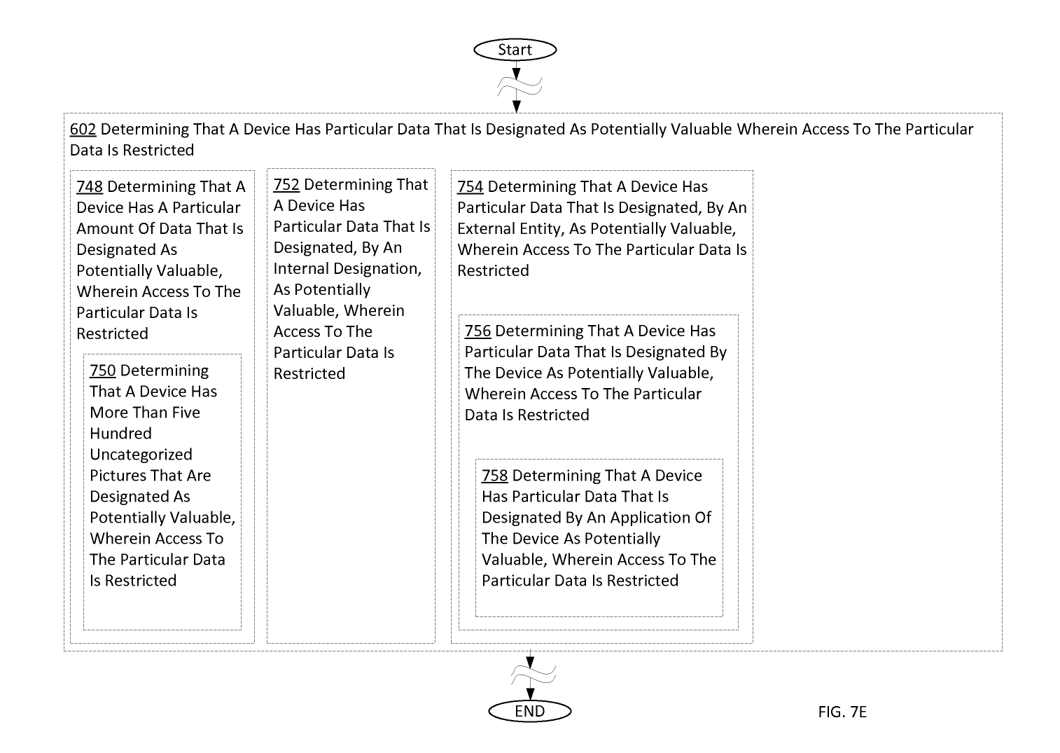

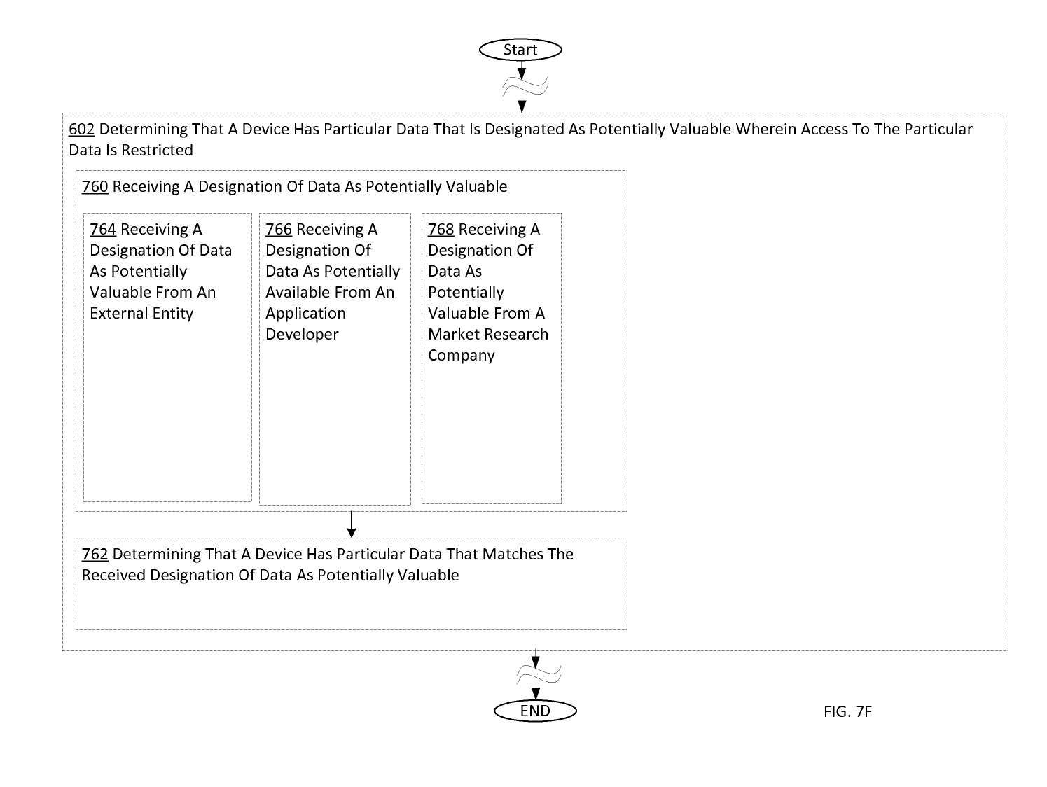

FIGS. 7A-7E depict various implementations of operation 602, depicting determining that a device has particular data that is designated as potentially valuable wherein access to the particular data is restricted according to embodiments. Referring now to FIG. 7A, operation 602 may include operation 702 depicting determining that a smartphone has location data that is designated as potentially valuable for which access to the location data is restricted. For example, FIG. 2, e.g., FIG. 2A, shows particular position data indicated as potentially valuable data presence on a smartphone device with restricted access finding module 202 determining (e.g., receiving data, e.g., from the device) indicating) that a smartphone has location data (e.g., data indicating the position of a smartphone, whether stored in memory or directly from a positioning sensor, e.g., a GPS sensor) that is designated as potentially valuable (e.g., a third party has sent a notice indicating that location value for a particular brand of smartphones is valuable to them) for which access to the location data is restricted (e.g., not every application loaded on the device can access the location data on the smartphone).

Referring again to FIG. 7A, operation 702 may include operation 704 depicting determining that a smartphone has a global positioning sensor that generates location data that is designated as potentially valuable, for which access to the location data is restricted. For example, FIG. 2, e.g., FIG. 2A, shows particular position data collected by a global positioning sensor indicated as potentially valuable data presence on a smartphone device with restricted access finding module 204 determining (e.g., receiving a notification from the smartphone manufacturer) that a smartphone has a global positioning sensor that generates location data that is designated as potentially valuable (e.g., the GPS sensor is indicating that the device is within Times Square, which has been determined by the City of New York as valuable for data collection purposes), for which access to the location data is restricted (e.g., third parties communicating with the device are generally denied access to the location data without a specific reason to have the data).

Referring again to FIG. 7A, operation 704 may include operation 706 depicting determining that the smartphone has the global positioning sensor that generates location data that is designated as potentially valuable for its role in delivering targeted advertising to a user via the device, for which access to the location data is restricted. For example, FIG. 2, e.g., FIG. 2A, shows particular position data collected by a global positioning sensor indicated as potentially valuable for perceived usefulness in assisting with delivering targeted advertising data presence on a smartphone device with restricted access finding module 206 determining that the smartphone has the global positioning sensor that generates location data (e.g., a location of the device, and ostensibly, the user) that is designated as potentially valuable (e.g., internal controls indicate that location data is one of the highest-value pieces of data generated by cellular telephone devices) for its role in delivering targeted advertising (e.g., preventing the user from seeing ads for businesses not in his or her region, e.g., preventing seeing Sonic restaurant ads in the District of Columbia area) to a user via the device (e.g., the ads are delivered to the device for displaying to the user, with the device having varying levels of control regarding the displaying of the ad), for which access to the location data is restricted (e.g., the device does not generally transmit the location data to entities exterior to the smartphone).

Referring again to FIG. 7A, operation 706 may include operation 708 depicting determining that the smartphone has the global positioning sensor that generates location data that is designated as potentially valuable for its role in delivering targeted location-based advertising to the user via the device, for which access to the location data is forbidden to one or more entities. For example, FIG. 2, e.g., FIG. 2A, shows particular position data collected by a global positioning sensor indicated as potentially valuable for perceived usefulness in assisting with delivering targeted advertising data presence on a smartphone device with access forbidden to one or more entities finding module 208 determining that the smartphone has the global positioning sensor that generates location data that is designated as potentially valuable for its role in delivering targeted location-based advertising to the user via the device, for which access to the location data is forbidden to one or more entities (e.g., applications, users, devices in communication with, networks, and the like).

Referring now to FIG. 7B, operation 602 may include operation 710 depicting calculating, based on known information about a device, that the device has particular data that is designated as potentially valuable, wherein access to the particular data is restricted. For example, FIG. 2, e.g., FIG. 2B, shows particular data indicated as potentially valuable data presence on a device with restricted access calculating module 210 calculating (e.g., performing one or more operations, whether machine-based, human-based, or a combination of both), based on known information about a device (e.g., data that is not protected), that the device has particular data that is designated as potentially valuable (e.g., if the device has a thermometer and a memory, which may be known information (e.g., from the manufacturer, or publicly observable), calculating that the device stores temperature data regarding its locations, which may be valuable to a designer of a weather modeling software), wherein access to the particular data is restricted (e.g., the device does not broadcast that it stores temperature data).

Referring again to FIG. 7B, operation 710 may include operation 712 depicting calculating, based on data indicating that the device has a particular type of sensor, that the sensor is collecting particular data that is designated as potentially valuable, wherein access to the particular data is restricted. For example, FIG. 2, e.g., FIG. 2B, shows particular data indicated as potentially valuable data presence on a device with restricted access calculating based on information regarding a particular sensor module 212 calculating, based on data indicating that the device has a particular type of sensor (e.g., a velocity sensor), that the sensor is collecting particular data (e.g., average highway speeds for a common commute) that is designated as potentially valuable (e.g., a highway transportation official has designated that velocity data for a particular route is valuable), wherein access to the particular data (e.g., velocity data collected by the velocity sensor) is restricted.

Referring again to FIG. 7B, operation 712 may include operation 714 depicting calculating, based on data indicating that a motor vehicle control system has a velocity sensor, that the sensor is collecting velocity data that is designated as potentially valuable, for which access to the velocity data is restricted. For example, FIG. 2, e.g., FIG. 2B, shows particular data indicated as potentially valuable data presence on a device with restricted access calculating based on information regarding velocity data collected by a particular sensor module 214 calculating, based on data indicating that a motor vehicle control system has a velocity sensor, that the sensor is collecting velocity data that is designated as potentially valuable (e.g., an insurance company has requested data from that particular device, it may not be the velocity data, but rather the device which makes the data valuable), for which access to the velocity data is restricted.

Referring again to FIG. 7B, operation 714 may include operation 716 depicting calculating, based on data indicating that a motor vehicle control system has a velocity sensor, that the sensor is collecting velocity data that is designated by a discrete entity as potentially valuable to determine whether the vehicle is exceeding a speed limit, for which access to the velocity data is restricted. For example, FIG. 2, e.g., FIG. 2B, shows particular velocity data indicated as potentially valuable by an entity requesting information about one or more vehicles exceeding a speed limit, said presence of velocity data on a motor vehicle control system configured to restrict access to the particular velocity data, calculating based on information regarding velocity data collected by a particular sensor module 216 calculating, based on data indicating that a motor vehicle control system has a velocity sensor, that the sensor is collecting velocity data that is designated by a discrete entity as potentially valuable to determine whether the vehicle is exceeding a speed limit, for which access to the velocity data is restricted.

Referring now to FIG. 7C, operation 602 may include operation 718 depicting receiving an indicator indicating that the device has particular data that is designated as potentially valuable wherein access to the particular data is restricted. For example, FIG. 2, e.g., FIG. 2C, shows indicator describing particular data indicated as potentially valuable data presence on a device with restricted access receiving module 218 receiving an indicator (e.g., a message sent from a device) indicating that the device has particular data (e.g., picture data) that is designated as potentially valuable (e.g., for linking to friends in a social networking network), wherein access to the particular data is restricted.

Referring again to FIG. 7C, operation 718 may include operation 720 depicting receiving a data indicator, from the device, indicating that the device has particular data that is designated as potentially valuable, wherein access to the particular data is restricted. For example, FIG. 2, e.g., FIG. 2C, shows data indicator describing particular data indicated as potentially valuable data presence on a device with restricted access receiving module 220 receiving a data indicator (e.g., an indicator comprising data, e.g., a portion of the particular data, although not necessarily so), from the device (e.g., the tablet device), indicating that the device has particular data (e.g., location data) that is designated as potentially valuable (e.g., for context in studying the device movement patterns), wherein access to the particular data is restricted.

Referring again to FIG. 7C, operation 720 may include operation 722 depicting receiving a data indicator, from a monitoring application running on the device, indicating that the device has particular data that is designated as potentially valuable, wherein access to the particular data is restricted. For example, FIG. 2, e.g., FIG. 2C, shows data indicator describing particular data indicated as potentially valuable data presence on a device with restricted access receiving from device monitoring application module 222 receiving a data indicator, from a monitoring application (e.g., an application that has access to restricted data, and monitors to see if any of the data collected is particular data that is designated as potentially valuable, e.g., if pictures of a celebrity are designated as valuable, then the monitoring application may look at the pictures taken by the device to perform facial recognition to determine if any of the pictures are pictures of the celebrity, in which case a data indicator is sent) running on the device (e.g., a smartphone with a camera enabled), indicating that the device has particular data (e.g., a picture of a particular celebrity) that is designated as potentially valuable, wherein access to the particular data is restricted.

Referring again to FIG. 7C, operation 720 may include operation 724 depicting receiving a data indicator, from a program that received input from a user, indicating that the device has particular data that is designated as potentially valuable, wherein access to the particular data is restricted. For example, FIG. 2, e.g., FIG. 2C, shows data indicator describing particular data indicated as potentially valuable data presence on a device with restricted access receiving from application configured to receive user input module 224 receiving a data indicator, from a program that received input from a user (e.g., a user typing into a keyboard), indicating that the device (e.g., an enterprise computer on a corporate network), indicating that the device has particular data (e.g., a time breakdown of the activities performed by the user on the computer) that is designated as potentially valuable (e.g., valuable to an owner of the device, in addition to being valuable to the user of the device, but for a different reason), wherein access to the particular data (e.g., the time breakdown of the activities performed by the user on the computer) is restricted (e.g., the owner of the device cannot otherwise access the user's data, due to workplace privacy regulations, without user waiver).

Referring again to FIG. 7C, operation 718 may include operation 726 depicting receiving a data indicator, from a communication network on which the device is communicating, indicating that the device has particular data that is designated as potentially valuable, wherein access to the particular data is restricted. For example, FIG. 2, e.g., FIG. 2C, shows data indicator describing particular data indicated as potentially valuable data presence on a device with restricted access receiving from communication network module 226 receiving a data indicator, from a communication network (e.g., a cellular service provider) on which the device (e.g., a smartphone) is communicating, indicating that the device has particular data (e.g., location data indicating that the device is inside a very exclusive celebrity party, and may have an opportunity to take very valuable pictures) that is designated as potentially valuable, wherein access to the particular data (e.g., the location data) is restricted.

Referring again to FIG. 7C, operation 602 may include operation 728 depicting polling one or more devices, to determine that a device of the one or more devices has particular data that is designated as potentially valuable, wherein access to the particular data is restricted. For example, FIG. 2, e.g., FIG. 2C, shows particular data indicated as potentially valuable data presence on a device with restricted access finding using polling of one or more devices module 228 polling one or more devices (e.g., one or more tablet devices), to determine that a device of the one or more devices has particular data (e.g., location data) that is designated as potentially valuable, wherein access to the particular data is restricted.

Referring again to FIG. 7C, operation 602 may include operation 730 depicting determining that a device has stored particular data that is designated as potentially valuable, wherein access to the particular data is restricted. For example, FIG. 2, e.g., FIG. 2C, shows particular data indicated as potentially valuable data stored on a device with restricted access determining module 230 determining that a device (e.g., a laptop computer) has stored particular data (e.g., data indicating how many contacts are in a user's contact list), wherein access to the particular data (e.g., the data indicating how many contacts are in a user's contact list) is restricted (e.g., only persons in the user's contact list can access the user's contact list data).

Referring now to FIG. 7D, operation 602 may include operation 732 depicting determining that a device has control over particular data stored at a remote location that is designated as potentially valuable, wherein access to the particular data is restricted. For example, FIG. 2, e.g., FIG. 2C, shows particular data indicated as potentially valuable data under control remotely by a device with restricted access determining module 232 determining that a device (e.g., a desktop computer) has control over particular data (e.g., a business networking site, e.g., LinkedIn, client contact list) stored at a remote location (e.g., LinkedIn's servers) that is designated as potentially valuable (e.g., advertisers know that people in the LinkedIn list might have similar shopping habits as the user), wherein access to the particular data is restricted (e.g., the LinkedIn server will not grant an entity access to the client contact list without the proper credentials, e.g., a login and a password).

Referring again to FIG. 7D, operation 602 may include operation 734 depicting monitoring public data to determine a likelihood that the device has particular data that is designated as potentially valuable wherein access to the particular data is restricted. For example, FIG. 2, e.g., FIG. 2C, shows likelihood particular data indicated as potentially valuable data presence on a device with restricted access estimating based on public data monitoring module 234 monitoring public data (e.g., data posted to a social networking site, e.g., Facebook) to determine a likelihood that the device has particular data (e.g., if a Facebook posting says “going to the play Les Mis at the Met in New York,” then it may be determined that a device at that location may have microphone data indicating how loud the performance was inside a particular part of the theater, which may be valuable to the theater managers) that is designated as potentially valuable, wherein access to the particular data is restricted (e.g., the theater managers do not have access to microphone data without explicitly getting permission from the device).

Referring again to FIG. 7D, operation 734 may include operation 736 depicting monitoring one or more social networking sites to determine a likelihood that the device has particular data that is designated as potentially valuable, wherein access to the particular data is restricted. For example, FIG. 2, e.g., FIG. 2D, shows likelihood particular data indicated as potentially valuable data presence on a device with restricted access estimating based on public data on one or more social networking sites monitoring module 236 monitoring one or more social networking sites (e.g., Twitter), to determine a likelihood (e.g., if a Twitter post says “goin for a bike ride LOL”), then it may be inferred that the device has a likelihood of having particular data (e.g., data about a bicycle ride across a particular bridge) that is designated as potentially valuable (e.g., a bicycle enthusiast newsletter producer may be looking to put together an email list), wherein access to the particular data (e.g., one or more locations where the bicycle is ridden) is restricted.

Referring again to FIG. 7D, operation 734 may include operation 738 depicting monitoring designated-public data that is other than the particular data and that a user of the device has designated as publicly available, to determine a likelihood that the device has particular data that is designated as potentially valuable, wherein access to the particular data is restricted. For example, FIG. 2, e.g., FIG. 2D, shows likelihood particular data indicated as potentially valuable data presence on a device with restricted access estimating based on monitoring data designated by a user as public that may be related to the particular data module 238 monitoring designated-public data (e.g., data that the user has designated on her device as “public,” e.g., “see what song I'm playing now,” which allows anyone to see what songs the user is playing on her portable music device that is internet-connected) that is other than particular data (e.g., the particular data is how many songs by a particular artist are stored on the device) and that a user of the device has designated as publicly available (e.g., the “current song playing” is public, but the particular data, e.g., “how many songs by this artist are stored on the device” is not public), to determine a likelihood that the device has particular data (e.g., data indicating more than twenty songs by the same artist) that is designated as potentially valuable (e.g., indicating that the user is a real “fan” that may be interested in buying a t-shirt or other memorabilia), wherein access to the particular data is restricted (e.g., the number of songs by a particular artist stored on the device is not made public).

Referring again to FIG. 7D, operation 602 may include operation 740 depicting determining that a device has particular data of a type that is designated as potentially valuable, wherein access to the particular data is restricted. For example, FIG. 2, e.g., FIG. 2D, shows particular data having a data type that is indicated as potentially valuable presence on a device with restricted access determining module 240 determining that a device has particular data of a type (e.g., velocity data) that is designated as potentially valuable (e.g., if in a car, by law enforcement officers), wherein access to the particular data is restricted.

Referring again to FIG. 7D, operation 740 may include operation 742 depicting determining that a device has particular data that is temperature data designated as potentially valuable, wherein access to the particular data is restricted. For example, FIG. 2, e.g., FIG. 2D, shows particular data having a temperature data type that is indicated as potentially valuable presence on a device with restricted access determining module 242 determining that a device (e.g., a home weather station) has particular data that is temperature data designated as potentially valuable (e.g., was collected in the 72 hours before a tornado hit that spot), wherein access to the particular data is restricted.

Referring again to FIG. 7D, operation 740 may include operation 744 depicting determining that a device has particular data having one or more values designated as potentially valuable, wherein access to the particular data is restricted. For example, FIG. 2, e.g., FIG. 2D, shows particular data including data having one or more values that indicate the particular data as potentially valuable presence on a device with restricted access determining module 244 determining that a device has particular data having one or more values (e.g., picture data indicating not the pictures themselves, but that there are more than one thousand unsorted pictures) designated as potentially valuable (e.g., this user might be a good target for picture sorting applications), wherein access to the particular data (e.g., either picture data, or data indicating how many pictures are stored on the device is restricted (e.g., a limited set of entities may have access to the number of pictures stored on the device, and a further limited set of entities may have access to the pictures themselves).

Referring again to FIG. 7D, operation 744 may include operation 746 depicting determining that a device has particular position data having a value indicating that the device is in a proximity to Times Square, wherein access to the particular data is restricted. For example, FIG. 2, e.g., FIG. 2D, shows particular data including position data having one or more values indicating a position in times square, said indicating values indicating that the particular data may be potentially valuable presence on a device with restricted access determining module 246 determining that a device has particular position data having a value indicating that the device is in a proximity to Times Square, wherein access to the particular data is restricted.

Referring now to FIG. 7E, operation 602 may include operation 748 depicting determining that a device has a particular amount of data that is designated as potentially valuable, wherein access to the particular data is restricted. For example, FIG. 2, e.g., FIG. 2E, shows particular data amount that is indicated as potentially valuable data presence on a device with restricted access finding module 248 determining that a device has a particular amount of data (e.g., more than one hundred e-mail contacts in a contact list) that is designated as potentially valuable (e.g., capturing the user's contact list results in a large pool of potential new contacts), wherein access to the particular data (e.g., the device contact list) is restricted.

Referring again to FIG. 7E, operation 748 may include operation 750 depicting determining that a device has more than five hundred uncategorized pictures that are designated as potentially valuable, wherein access to the particular data is restricted. For example, FIG. 2, e.g., FIG. 2E, shows particular data amount that is more than five hundred pictures, said amount of data indicated as potentially valuable data presence on a device with restricted access finding module 250 determining that a device (e.g., an internet-enabled camera device has more than five hundred uncategorized pictures that are designated as potentially valuable, wherein access to the particular data is restricted.

Referring again to FIG. 7E, operation 602 may include operation 752 depicting determining that a device has particular data that is designated, by an internal designation, as potentially valuable, wherein access to the particular data is restricted. For example, FIG. 2, e.g., FIG. 2E, shows particular data internally designated as potentially valuable data presence on a device with restricted access finding module 252 determining that a device has particular data (e.g., a list of the last fifty web pages visited by the device) that is designated, by an internal designation (e.g., by the entity doing the determining), as potentially valuable, wherein access to the particular data is restricted.

Referring again to FIG. 7E, operation 602 may include operation 754 depicting determining that a device has particular data that is designated, by an external entity, as potentially valuable, wherein access to the particular data is restricted. For example, FIG. 2, e.g., FIG. 2E, shows particular data designated by an external entity as potentially valuable data presence on a device with restricted access finding module 254 determining that a device has particular data (e.g., location data of the last five restaurants the device was located at for more than one-half an hour) that is designated, by an external entity (e.g., the device that collected the data, e.g., by a user of the device, or by a monitoring application of the device), as potentially valuable, wherein access to the particular data is restricted (e.g., outside parties do not have access to the data without permission).

Referring again to FIG. 7E, operation 754 may include operation 756 depicting determining that a device has particular data that is designated by the device as potentially valuable, wherein access to the particular data is restricted. For example, FIG. 2, e.g., FIG. 2E, shows particular data designated by the device as potentially valuable data presence on a device with restricted access finding module 256 determining that a device has particular data (e.g., a number of text messages sent in the last 48 hours) that is designated by the device (e.g., a smartphone) as potentially valuable (e.g., the numbers show texting trends which can be used for market research), wherein access to the particular data is restricted.

Referring again to FIG. 7E, operation 756 may include operation 758 depicting determining that a device has particular data that is designated by an application of the device as potentially valuable, wherein access to the particular data is restricted. For example, FIG. 2, e.g., FIG. 2E, shows particular data designated by an application operating on the device as potentially valuable data presence on a device with restricted access finding module 258 determining that a device has particular data that is designated by an application of the device (e.g., a tablet computer, with a data monitoring application running in the background as part of the operating system) as potentially valuable (e.g., data indicating which applications are the most commonly used on the device), wherein access to the particular data is restricted (e.g., other applications that do not have operating-system level access cannot view this data, but the operating system application can).

Referring now to FIG. 7F, operation 602 may include operation 760 depicting receiving a designation of data as potentially valuable. For example, FIG. 2, e.g., FIG. 2F, shows designation of designated data as potentially valuable receiving module 260 receiving a designation of data (e.g., “location data for devices that are on the National Mall at the 2013 inauguration”) as potentially valuable.

Referring again to FIG. 7F, operation 602 may include operation 762 depicting determining that a device has particular data that matches the received designation of data as potentially valuable. For example, FIG. 2, e.g., FIG. 2F, shows matching particular data presence on a device with restricted access matching with potentially valuable designated data module 262 determining that a device (e.g., a smartphone) has particular data (e.g., location data) that matches the received designation of data (e.g., the particular data is location data indicating that the smartphone is located at the national mall) as potentially valuable.

Referring again to FIG. 7F, operation 760 may include operation 764 depicting receiving a designation of data as potentially valuable from an external entity. For example, FIG. 2, e.g., FIG. 2F, shows designation of designated data as potentially valuable receiving from external entity module 264 receiving a designation of data (e.g., an amount of data transferred by the device in the last six months) as potentially valuable from an external entity (e.g., a network provider).

Referring again to FIG. 7F, operation 760 may include operation 766 depicting receiving a designation of data as potentially valuable from an application developer. For example, FIG. 2, e.g., FIG. 2F, shows designation of designated data as potentially valuable receiving from application developer module 266 receiving a designation of data (e.g., data of how many devices are traveling between six and ten miles per hour for more than thirty minutes when an ambient temperature is greater than eighty degrees Fahrenheit) as potentially valuable from an application developer (e.g., a developer of applications used by runners).

Referring again to FIG. 7F, operation 760 may include operation 768 depicting receiving a designation of data as potentially valuable from a market research entity. For example, FIG. 2, e.g., FIG. 2F, shows designation of designated data as potentially valuable receiving from market research entity module 268 receiving a designation of data (e.g., data, for a set of devices located in a shopping mall, how much time the device spent in each store of the shopping mall) as potentially valuable from a market research entity.

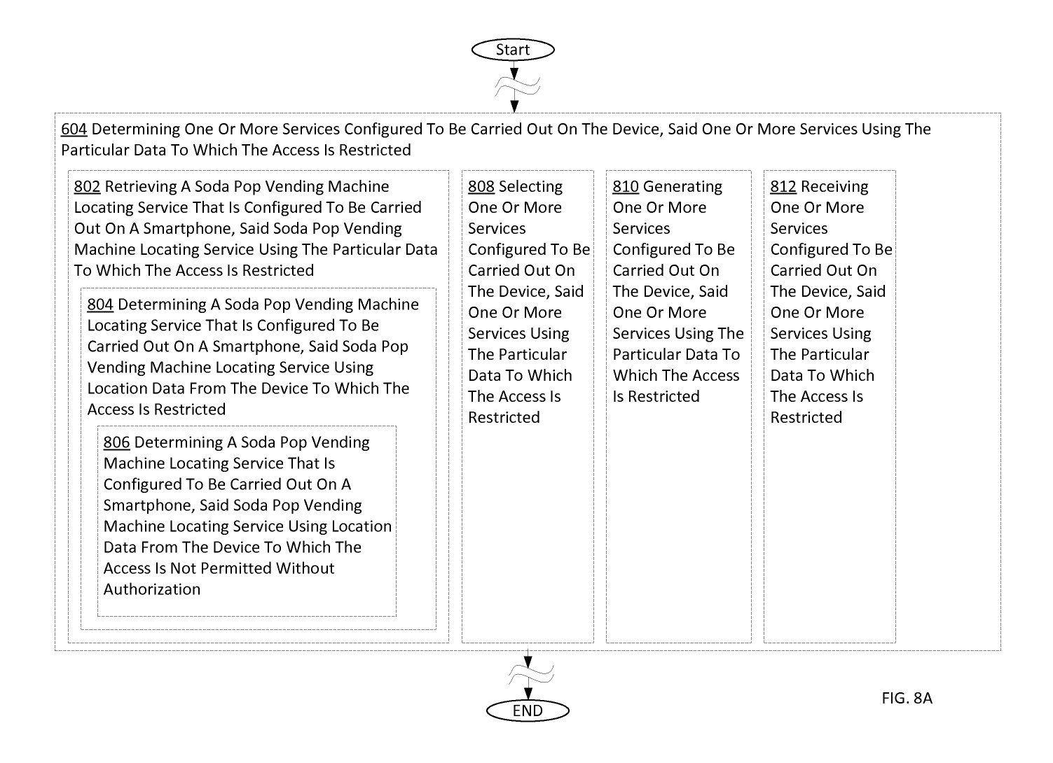

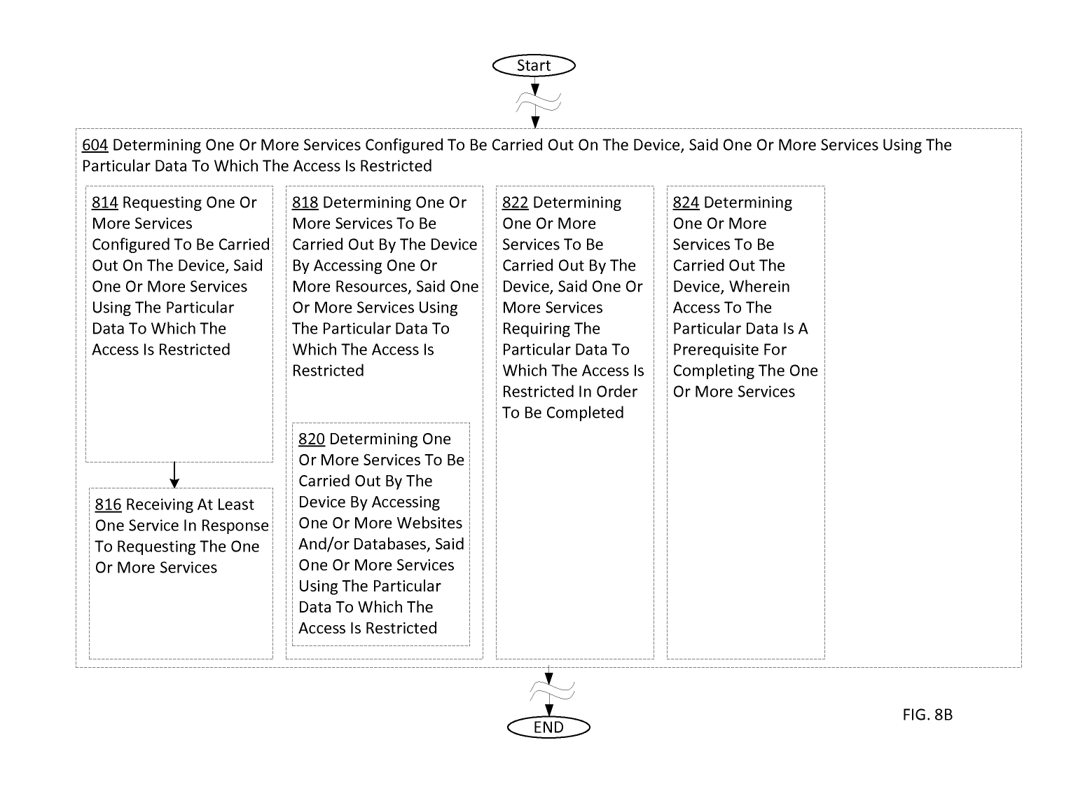

FIGS. 8A-8D depict various implementations of operation 504, depicting determining one or more services configured to be carried out on the device, said one or more services using the particular data to which the access is restricted, according to embodiments. Referring now to FIG. 8A, operation 604 may include operation 802 depicting retrieving a soda pop vending machine locating service that is configured to be carried out on a smartphone, said soda pop vending machine locating service using the particular data to which the access is restricted. For example, FIG. 3, e.g., FIG. 3A, shows soda pop vending machine locating device-based services configured to utilize particular data indicated as potentially valuable determining module 302 retrieving a soda pop vending machine locating service that is configured to be carried out on a smartphone, said soda pop vending machine locating service using the particular data (e.g., location data) to which the access is restricted.

Referring again to FIG. 8A, operation 802 may include operation 804 depicting determining a soda pop vending machine locating service that is configured to be carried out on a smartphone, said soda pop vending machine locating service using location data from the device to which the access is restricted. For example, FIG. 3, e.g., FIG. 3A, shows soda pop vending machine locating smartphone device-based services configured to utilize location data indicated as potentially valuable determining module 304 determining (e.g., selecting, e.g., from a list or set, after retrieval of the list or set) a soda pop vending machine locating service that is configured to be carried out on a smartphone, said soda pop vending machine locating service using location data from the device to which the access is restricted

Referring again to FIG. 8A, operation 804 may include operation 806 depicting determining a soda pop vending machine locating service that is configured to be carried out on a smartphone, said soda pop vending machine locating service using location data from the device to which the access is not permitted without authorization. For example, FIG. 3, e.g., FIG. 3A, shows soda pop vending machine locating smartphone device-based services configured to utilize location data that is indicated as potentially valuable and that requires authorization to be accessed determining module 306 determining (e.g., generating) a soda pop vending machine locating service that is configured to be carried out on a smartphone, said soda pop vending machine locating service using location data from the device to which the access is not permitted (e.g., not permitted to an outside entity, or to an application on the device that has been installed for fewer than ninety days, or an application on the device from a particular manufacturer) without authorization.

Referring again to FIG. 8A, operation 604 may include operation 808 depicting selecting one or more services configured to be carried out on the device, said one or more services using the particular data to which the access is restricted. For example, FIG. 3, e.g., FIG. 3A, shows one or more device-based services configured to utilize particular data indicated as potentially valuable selecting from a set of one or more device-based services module 308 selecting one or more services (e.g., an application that collects concert information and selects concerts a user of a device might be interested in, based on music listened to by a user of a device, e.g., a media player, or a device that includes a media player) configured to be carried out on the device (e.g., a portable music player), said one or more services using the particular data (e.g., data indicating the songs stored on the device) to which the access is restricted.

Referring again to FIG. 8A, operation 604 may include operation 810 depicting generating one or more services configured to be carried out on the device, said one or more services using the particular data to which the access is restricted. For example, FIG. 3, e.g., FIG. 3A, shows one or more device-based services configured to utilize particular data indicated as potentially valuable generating module 310 generating one or more services (e.g., a hiking trail status tracking application that tracks a usability of a particular hiking trail in the current climate conditions) configured to be carried out on the device (e.g., a hiker's watch with cellular signal connectivity), said one or more services using the particular data (e.g., temperature data) to which the access is restricted.

Referring again to FIG. 8A, operation 604 may include operation 812 depicting receiving one or more services configured to be carried out on the device, said one or more services using the particular data to which the access is restricted. For example, FIG. 3, e.g., FIG. 3A, shows one or more device-based services configured to utilize particular data indicated as potentially valuable receiving module 312 receiving one or more services (e.g., a bicycling trail information and status tracking application) configured to be carried out on the device (e.g., a smartphone), said one or more services using the particular data (e.g., velocity data) to which the access is restricted.

Referring now to FIG. 8B, operation 604 may include operation 814 depicting requesting one or more services configured to be carried out on the device, said one or more services using the particular data to which the access is restricted. For example, FIG. 3, e.g., FIG. 3B, shows one or more device-based services configured to utilize particular data indicated as potentially valuable requesting module 314 requesting one or more services (e.g., a data synchronization optimizing service that optimizes when data is transferred from the device to cloud storage) configured to be carried out on the device (e.g., a laptop computer), said one or more services using the particular data (e.g., signal strength for a wireless network) to which the access is restricted.

Referring again to FIG. 8B, operation 604 may include operation 816 depicting receiving at least one service in response to requesting the one or more services. For example, FIG. 3, e.g., FIG. 3B, shows one or more device-based services configured to utilize particular data indicated as potentially valuable receiving in response to request module 316 receiving at least one service (e.g., the data synchronization optimizing service) in response to requesting the one or more services.

Referring again to FIG. 8B, operation 604 may include operation 818 depicting determining one or more services to be carried out by the device by accessing one or more resources, said one or more services using the particular data to which the access is restricted. For example, FIG. 3, e.g., FIG. 3B, shows one or more device-based services configured to utilize particular data indicated as potentially valuable determining by accessing one or more resources module 318 determining one or more services (e.g., an application for organizing pictures) to be carried out by the device by accessing one or more resources (e.g., a facial recognition algorithm that can sort a user's pictures based on the faces that appear in them), said one or more services using the particular data (e.g., picture data) to which the access is restricted.

Referring again to FIG. 8B, operation 818 may include operation 820 depicting determining one or more services to be carried out by the device by accessing one or more websites and/or databases, said one or more services using the particular data to which the access is restricted. For example, FIG. 3, e.g., FIG. 3B, shows one or more device-based services configured to utilize particular data indicated as potentially valuable determining by accessing one or more web site resources and/or database resources module 320 determining one or more services (e.g., a fat loss monitoring service) to be carried out by the device (e.g., a smartphone) by accessing one or more websites and/or databases, said one or more services using the particular data to which the access is restricted.

Referring again to FIG. 8B, operation 604 may include operation 822 depicting determining one or more services to be carried out by the device, said one or more services requiring the particular data to which the access is restricted in order to be completed. For example, FIG. 3, e.g., FIG. 3B, shows one or more device-based services requiring particular data indicated as potentially valuable determining module 322 determining one or more services (e.g., a rest stop finding service) to be carried out by the device, said one or more services requiring the particular data to which the access is restricted in order to be completed.

Referring again to FIG. 8B, operation 604 may include operation 824 depicting determining one or more services to be carried out the device, wherein access to the particular data is a prerequisite for completing the one or more services. For example, FIG. 3, e.g., FIG. 3B, shows one or more device-based services for which obtaining particular data is a prerequisite, said particular data indicated as potentially valuable determining module 324 determining one or more services (e.g., a soda pop vending machine locating service) to be carried out the device, wherein access to the particular data is a prerequisite for completing the one or more services (e.g., the soda pop vending machine locating service).

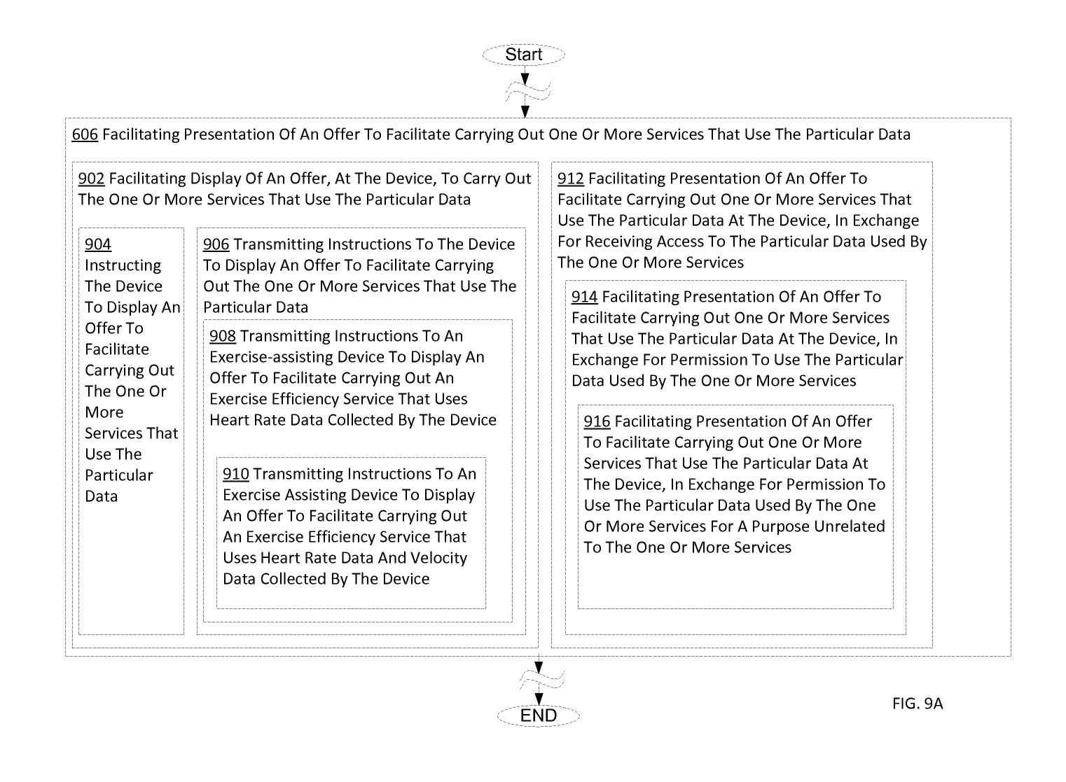

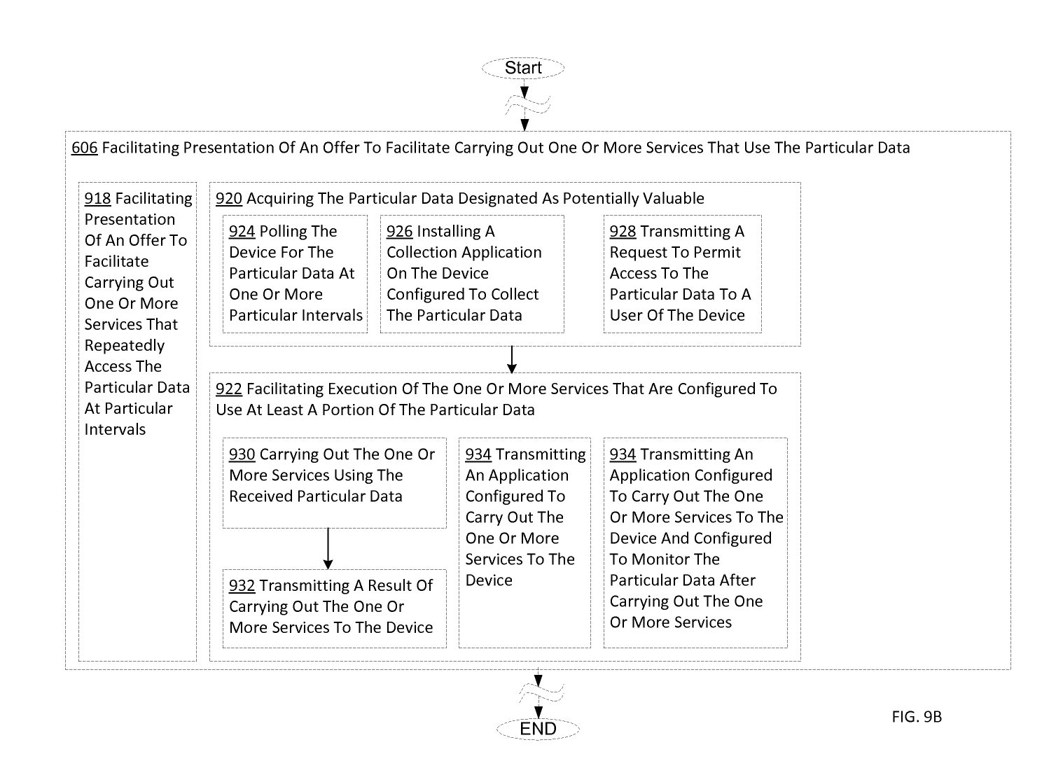

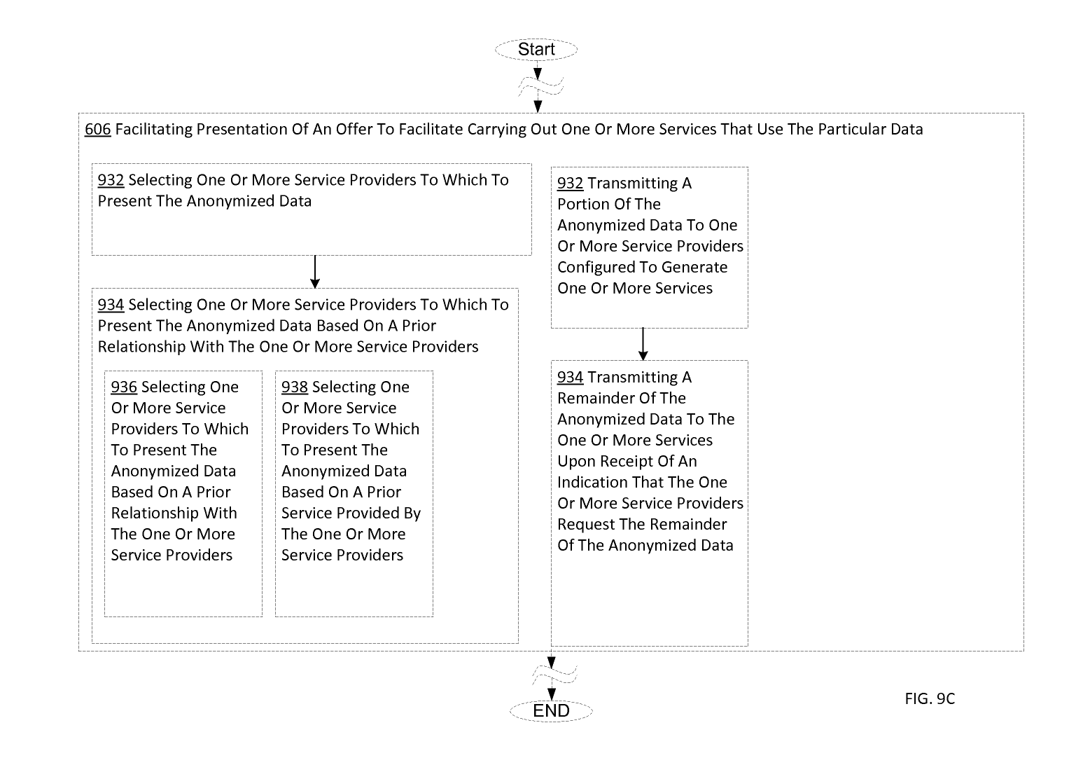

FIGS. 9A-9C depict various implementations of operation 606 depicting facilitating presentation of an offer to facilitate carrying out one or more services that use the particular data, according to embodiments. Referring now to FIG. 8A, operation 606 may include operation 902 depicting facilitating display of an offer, at the device, to carry out the one or more services that use the particular data. For example, FIG. 4, e.g., FIG. 4A, shows presentation of an offer, at the device, to facilitate carrying out of one or more device-based services using the particular data to the device facilitating module 402 facilitating display of an offer (e.g., “dear user, this is the service we can provide for you”) at the device (e.g., the user's music player), to carry out the one or more services (e.g., a music playlist creating service) that use the particular data (e.g., how often each song stored on a user's cloud playing service is played by the device).

Referring again to FIG. 9A, operation 902 may include operation 904 depicting instructing the device to display an offer to facilitate carrying out the one or more services that use the particular data. For example, FIG. 4, e.g., FIG. 4A, shows display of an offer to facilitate carrying out of one or more device-based services using the particular data device instructing module 404 instructing the device (e.g., a user's tablet device) to display (e.g., present on a screen of the device) an offer to facilitate carrying out the one or more services (e.g., a music playlist creating service) that use the particular data (e.g., favorite song identification data).

Referring again to FIG. 9A, operation 902 may include operation 906 depicting transmitting instructions to the device to display an offer to facilitate carrying out the one or more services that use the particular data. For example, FIG. 4, e.g., FIG. 4A, shows transmitting instructions for presenting an offer, at the device, to facilitate carrying out of one or more device-based services using the particular data to the device facilitating module 406 transmitting instructions to the device (e.g., a user's smartphone) to display an offer to facilitate carrying out the one or more services (e.g., a friend finding service) that use the particular data (e.g., a user's contact list).

Referring again to FIG. 9A, operation 906 may include operation 908 depicting transmitting instructions to an exercise-assisting device to display an offer to facilitate carrying out an exercise efficiency service that uses heart rate data collected by the device. For example, FIG. 4, e.g., FIG. 4A, shows transmitting instructions for presenting an offer, at an exercise-assist device, to facilitate carrying out of an exercise efficiency service using user heart rate data to the exercise-assist device facilitating module 408 transmitting instructions to an exercise-assisting device to display an offer to facilitate carrying out an exercise efficiency service that uses heart rate data collected by the device (e.g., a heart rate monitor issued by a hospital to a patient that has previously had a heart attack).

Referring again to FIG. 9A, operation 908 may include operation 910 depicting transmitting instructions to an exercise assisting device to display an offer to facilitate carrying out an exercise efficiency service that uses heart rate data and velocity data collected by the exercise assisting device. For example, FIG. 4, e.g., FIG. 4A, shows transmitting instructions for presenting an offer, at an exercise-assist device, to facilitate carrying out of an exercise efficiency service using user heart rate data and device velocity data to the exercise-assist device facilitating module 410 transmitting instructions to an exercise assisting device to display an offer to facilitate carrying out an exercise efficiency service that uses heart rate data and velocity data collected by the exercise assist device.

Referring again to FIG. 9A, operation 606 may include operation 912 depicting facilitating presentation of an offer to facilitate carrying out one or more services that use the particular data at the device, in exchange for receiving access to the particular data used by the one or more services. For example, FIG. 4, e.g., FIG. 4A, shows presentation of an offer of one or more device-based services executed on the device and using particular data located on the device, to the device facilitating module 412 facilitating presentation of an offer to facilitate carrying out one or more services (e.g., a bicycle-riding mapping application) that use the particular data (e.g., location data) at the device (e.g., a smart watch worn by the user), in exchange for receiving access (e.g., permission to copy and analyze) to the particular data (e.g., the location data) used by the one or more services

Referring again to FIG. 9A, operation 912 may include operation 914 depicting facilitating presentation of an offer to facilitate carrying out one or more services that use the particular data at the device, in exchange for permission to use the particular data used by the one or more services. For example, FIG. 4, e.g., FIG. 4A, shows presentation of an offer of one or more device-based services executed on the device and using particular data located on the device, to the device, in return for permission to use the particular data facilitating module 414 facilitating presentation of an offer to facilitate carrying out one or more services (e.g., a pickup football game scheduler that compares friends' locations and schedules) that use the particular data (e.g., the device's calendar) at the device, in exchange for permission to use the particular data (e.g., the user's calendar) used by the one or more services (e.g., when another person wants to use the pickup football game scheduler, access to this device's schedule has already been achieved, so the scheduler does not have to find that data).

Referring again to FIG. 9A, operation 914 may include operation 916 depicting facilitating presentation of an offer to facilitate carrying out one or more services that use the particular data at the device, in exchange for permission to use the particular data used by the one or more services for a purpose unrelated to the one or more services. For example, FIG. 4, e.g., FIG. 4A, shows presentation of an offer of one or more device-based services executed on the device and using particular data located on the device, to the device, in return for permission to use the particular data for a purpose not required to carry out the one or more services facilitating module 416 facilitating presentation of an offer to facilitate carrying out one or more services (e.g., a soda pop vending machine locating service) that use the particular data at the device (e.g., temperature data), in exchange for permission to use the particular data used by the one or more services for a purpose unrelated to the one or more services (e.g., to sell to a weather tracking service).

Referring now to FIG. 9B, operation 606 may include operation 918 depicting facilitating presentation of an offer to facilitate carrying out one or more services that repeatedly access the particular data at particular intervals. For example, FIG. 4, e.g., FIG. 4B, shows presentation of an offer of one or more device-based services using the particular data to the device facilitating module 418 facilitating presentation (e.g., offering to present, on the screen of a device) of an offer to facilitate carrying out (e.g., taking the measurements) one or more services (e.g., a 4G service signal strength evaluator) that repeatedly access the particular data (e.g., communication network signal strength) at particular intervals (e.g., every ten seconds).

Referring again to FIG. 9B, operation 606 may include operation 920 depicting acquiring the particular data designated as potentially valuable. For example, FIG. 4, e.g., FIG. 4B, shows particular data indicated as potentially valuable receiving module 420 acquiring the particular data (e.g., a table of 4G LTE communication network speeds detected at various locations the user visited) designated as potentially valuable (e.g., previously designated by a communication network provider, e.g., a 4G LTE communication network provider).

Referring again to FIG. 9B, operation 606 may include operation 922 depicting facilitating execution of the one or more services that are configured to use at least a portion of the particular data. For example, FIG. 4, e.g., FIG. 4B, shows execution of the one or more device-based services using the particular data facilitating module 422 facilitating execution of the one or more services (e.g., a rest stop finding service) that are configured to use at least a portion of the particular data (e.g., to use a device, e.g., an in-vehicle navigation system, speed).

Referring again to FIG. 9B, operation 920 may include operation 924 depicting polling the device for the particular data at one or more particular intervals. For example, FIG. 4, e.g., FIG. 4B, shows particular data indicated as potentially valuable polling at a particular interval module 424 polling the device (e.g., a tablet device) for the particular data (e.g., wireless signal strength data) at one or more particular intervals (e.g., every hour).

Referring again to FIG. 9B, operation 920 may include operation 926 depicting installing a collection application on the device configured to collect the particular data. For example, FIG. 4, e.g., FIG. 4B, shows application configured to collect particular data installation module 426 installing a collection application on the device (e.g., a personal navigation system) configured to collect the particular data (e.g., location data for a device).

Referring again to FIG. 9B, operation 920 may include operation 928 depicting receiving authorization to access the particular data from a user of the device. For example, FIG. 4, e.g., FIG. 4B, shows authorization to access the particular data receiving from a user of the device module 428 receiving authorization (e.g., a login and a password to a social networking site) to access the particular data (e.g., a user's Facebook friends list) from a user of the device (e.g., the user enters the login and password).

Referring again to FIG. 9B, operation 922 may include operation 930 depicting carrying out the one or more services using the received particular data. For example, FIG. 4, e.g., FIG. 4B, shows one or more device-based services executing using the particular data module 430 carrying out the one or more services (e.g., an application for organizing pictures) using the received particular data (e.g., the unorganized pictures).

Referring again to FIG. 9B, operation 922 may include operation 932 depicting transmitting a result of carrying out the one or more services to the device. For example, FIG. 4, e.g., FIG. 4B, shows one or more results of the one or more device-based services transmitting to the device module 432 transmitting a result (e.g., a list of one or more concerts found in the area) of carrying out the one or more services (e.g., a service designed to find concerts in a user's area based on the music played by the device and the device location).

Referring again to FIG. 9B, operation 922 may include operation 934 depicting transmitting an application configured to carry out the one or more services to the device. For example, FIG. 4, e.g., FIG. 4B, shows one or more device-based applications configured to carry out at least a portion of the one or more device-based services transmitting to the device module 434 transmitting an application configured to carry out the one or more services (e.g., a bicycling trail information and status tracking application) to the device (e.g., a bicycle assisting device mounted to bicycle handlebars).

Referring again to FIG. 9B, operation 922 may include operation 936 depicting transmitting an application configured to carry out the one or more services to the device and configured to monitor the particular data after carrying out the one or more services. For example, FIG. 4, e.g., FIG. 4B, shows one or more device-based applications configured to carry out at least a portion of the one or more device-based services and to monitor one or more properties of the particular data after carrying out the at least a portion of the one or more device-based services transmitting to the device module 436 transmitting an application configured to carry out the one or more services (e.g., a hiking trail status tracking application that tracks a usability of a particular hiking trail in the current climate conditions) to the device and configured to monitor the particular data (e.g., temperature data) after carrying out the one or more services (e.g., the hiking trail status tracking application that tracks a usability of a particular hiking trail in the current climate conditions)

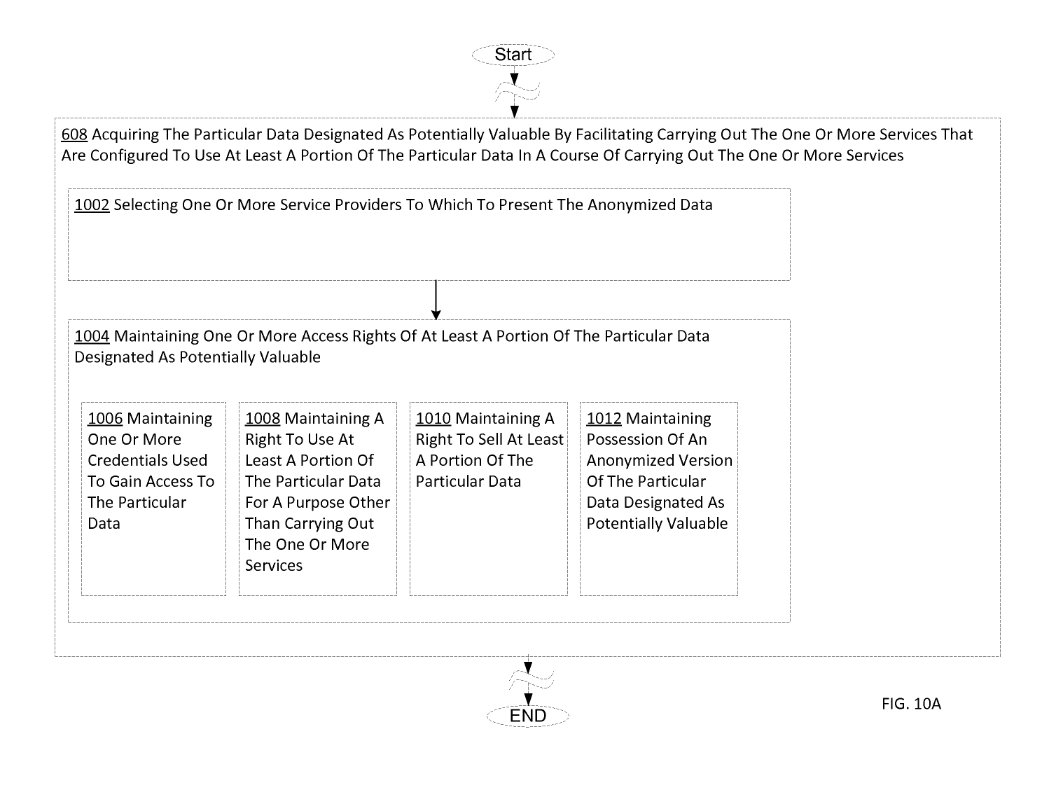

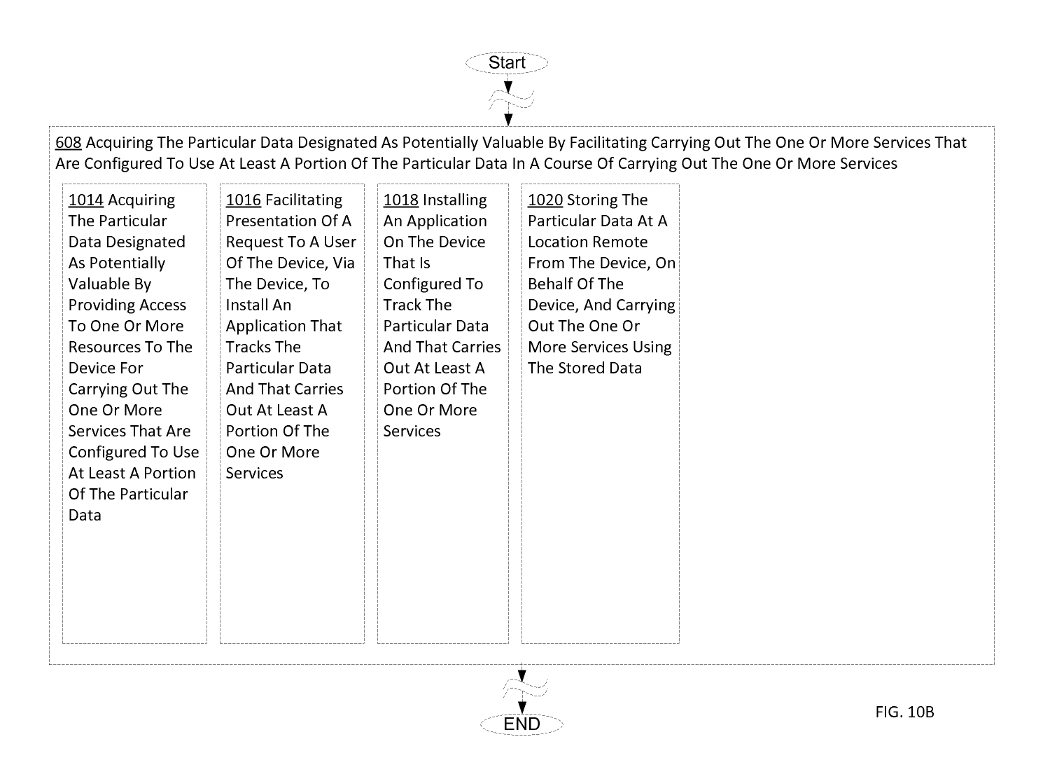

FIGS. 10A-10C depict various implementations of operation 608 depicting acquiring the particular data designated as potentially valuable by facilitating carrying out the one or more services that are configured to use at least a portion of the particular data in a course of carrying out the one or more services, according to embodiments. Referring now to FIG. 10A, operation 608 may include operation 1002 depicting carrying out the one or more services using at least a portion of the particular data to carry out the one or more services. For example, FIG. 5, e.g., FIG. 5A, shows one or more determined device-based services execution facilitating module 502 carrying out the one or more services (e.g., an application that collects concert information and selects concerts a user of a device might be interested in, based on music listened to by a user of a device, e.g., a media player, or a device that includes a media player) using at least a portion of the particular data (e.g., data indicating of the songs stored on the device, which is stored at one location on the device and has access rights set X, and the frequency with which they are played, which is stored at another location on the device and has access rights set Y) to carry out the one or more services.

Referring again to FIG. 10A, operation 608 may include operation 1004 depicting maintaining one or more access rights of at least a portion of the particular data designated as potentially valuable. For example, FIG. 5, e.g., FIG. 5A, shows one or more access rights of at least a portion of the particular data indicated as potentially valuable maintaining module 504 maintaining one or more access rights (e.g., one or more of the rights to read, write, copy, modify, transfer, operate upon, and the like) of at least a portion of the particular data (e.g., a list of the last hundred calls made by the user) designated as potentially valuable.

Referring again to FIG. 10A, operation 1004 may include operation 1006 depicting maintaining one or more credentials used to gain access to the particular data. For example, FIG. 5, e.g., FIG. 5A, shows one or more credentials used to gain access to at least a portion of the particular data indicated as potentially valuable storing module 506 maintaining one or more credentials (e.g., a login and/or a password, to unlock or decrypt data, or to a particular storage medium, or to a particular site, database, repository, or the like) used to gain access to the particular data (e.g., location data of the device).

Referring again to FIG. 10A, operation 1004 may include operation 1008 depicting maintaining a right to use at least a portion of the particular data for a purpose other than carrying out the one or more services. For example, FIG. 5, e.g., FIG. 5A, shows access permission to utilize at least a portion of the particular data indicated as potentially valuable maintaining module 508 maintaining a right (e.g., maintaining an ability and/or permission) to use (e.g., one or more of read, write, transfer, observe, analyze, and the like) at least a portion of the particular data (e.g., an average speed of bicycle treks taken by the user) for a purpose other than carrying out the one or more services (e.g., for determining if the user is a potential candidate for marketing hard core bicycling supplies).

Referring again to FIG. 10A, operation 1004 may include operation 1010 depicting maintaining a right to sell at least a portion of the particular data. For example, FIG. 5, e.g., FIG. 5A, shows permission to sell at least a portion of the particular data indicated as potentially valuable maintaining module 508 maintaining a right to sell (e.g., exchange to a third party for goods, services, or legal tender, whether physical or electronic) at least a portion of the particular data (e.g., restaurant reviews entered using a keyboard of the device).

Referring again to FIG. 10A, operation 1004 may include operation 1012 depicting maintaining possession of an anonymized version of the particular data designated as potentially valuable. For example, FIG. 5, e.g., FIG. 5A, shows permission to indefinitely store an anonymized version of at least a portion of the particular data indicated as potentially valuable maintaining module 512 maintaining possession (e.g., maintaining a copy of, or access to a copy of) an anonymized version (e.g., a version with uniquely identifying data removed or altered to be nonrecognizable) of the particular data (e.g., bank account data) designated as potentially valuable.

Referring now to FIG. 10B, operation 608 may include operation 1014 depicting acquiring the particular data designated as potentially valuable by providing access to one or more resources to the device for carrying out the one or more services that are configured to use at least a portion of the particular data. For example, FIG. 5, e.g., FIG. 5B, shows access to particular data indicated as potentially valuable obtaining by providing one or more resources to the device for use in execution of at least a portion of the one or more determined device-based services that use the particular data module 514 acquiring the particular data (e.g., a number of hours spent playing games on a gaming system) designated as potentially valuable (e.g., for marketing more specific types of games to be downloaded over the device) by providing access to one or more resources to the device (e.g., a resource that can suggest new games based on playing patterns) for carrying out the one or more services (e.g., tracking gameplay and offering new games based on a user's gameplay habits) that are configured to use at least a portion of the particular data (e.g., the data of a number of hours spent playing games on a gaming system).

Referring again to FIG. 10B, operation 608 may include operation 1016 depicting facilitating presentation of a request to a user of the device, via the device, to install an application that tracks the particular data and that carries out at least a portion of the one or more services. For example, FIG. 5, e.g., FIG. 5B, shows access to particular data indicated as potentially valuable obtaining by facilitating presentation of a request to a user of the device that facilitates execution of the one or more determined device-based services and that tracks the particular data indicated as potentially valuable module 516 facilitating presentation of a request to a user of the device, via the device, to install an application (e.g., a calorie-burning application that measures body temperature, water balance, and sweat levels) that tracks the particular data (e.g., body temperature) and that carries out at least a portion of the one or more services (e.g., health tracking)

Referring again to FIG. 10B, operation 608 may include operation 1018 depicting installing an application on the device that is configured to track the particular data and that carries out at least a portion of the one or more services. For example, FIG. 5, e.g., FIG. 5B, shows access to particular data indicated as potentially valuable obtaining by installing an application that facilitates execution of the one or more determined device-based services and that tracks the particular data indicated as potentially valuable module 518 installing an application on the device that is configured to track the particular data (e.g., heart rate data) and that carries out at least a portion of the one or more services (e.g., a heart attack watch monitor that watches heart activity).

Referring again to FIG. 10B, operation 608 may include operation 1020 depicting storing the particular data at a location remote from the device, on behalf of the device, and carrying out the one or more services using the stored data. For example, FIG. 5, e.g., FIG. 5B, shows access to particular data indicated as potentially valuable obtaining by storing the particular data at a location remote the device and facilitating execution of the one or more determined device-based services using the remotely-stored particular data module 520 storing the particular data (e.g., data regarding how many text messages a user sent last month) at a location remote from the device (e.g., on an internal hard drive), on behalf of the device (e.g., for the benefit of the device, e.g., to track text message usage to help a user of the device pick the best cellular service plan), and carrying out the one or more services (e.g., a phone usage analysis service) using the stored data (e.g., the number of text messages a user sent in the last month).

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Throughout this application, the terms “in an embodiment,” ‘in one embodiment,” “in some embodiments,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
determining that a device has particular data that is designated as potentially valuable wherein access to the particular data is restricted;
determining one or more services configured to be carried out on the device, said one or more services using the particular data to which the access is restricted;
facilitating presentation of an offer to facilitate carrying out one or more services that use at least a portion of the particular data; and
acquiring the particular data designated as potentially valuable by facilitating carrying out the one or more services that are configured to use at least a portion of the particular data in a course of carrying out the one or more services.

2. (canceled)

3. (canceled)

4. (canceled)

5. (canceled)

6. The computationally-implemented implemented method of claim 1, wherein said determining that a device has particular data that is designated as potentially valuable wherein access to the particular data is restricted comprises:
calculating, based on known information about a device, that the device has particular data that is designated as potentially valuable, wherein access to the particular data is restricted.

7. The computationally-implemented method of claim 6, wherein said calculating, based on known information about a device, that the device has particular data that is designated as potentially valuable, wherein access to the particular data is restricted comprises:
calculating, based on data indicating that the device has a particular type of sensor, that the sensor is collecting particular data that is designated as potentially valuable, wherein access to the particular data is restricted.

8. (canceled)

9. (canceled)

10. The computationally-implemented method of claim 1, wherein said determining that a device has particular data that is designated as potentially valuable wherein access to the particular data is restricted comprises:
receiving an indicator indicating that the device has particular data that is designated as potentially valuable wherein access to the particular data is restricted.

11. The computationally-implemented method of claim 10, wherein said receiving an indicator indicating that the device has particular data that is designated as potentially valuable wherein access to the particular data is restricted comprises:
receiving a data indicator, from the device, indicating that the device has particular data that is designated as potentially valuable, wherein access to the particular data is restricted.

12. The computationally-implemented method of claim 11, wherein said receiving a data indicator, from the device, indicating that the device has particular data that is designated as potentially valuable, wherein access to the particular data is restricted comprises:
receiving a data indicator, from a monitoring application running on the device, indicating that the device has particular data that is designated as potentially valuable, wherein access to the particular data is restricted.

13. (canceled)

14. The computationally-implemented method of claim 10, wherein said receiving an indicator indicating that the device has particular data that is designated as potentially valuable wherein access to the particular data is restricted comprises:
receiving a data indicator, from a communication network on which the device is communicating, indicating that the device has particular data that is designated as potentially valuable, wherein access to the particular data is restricted.

15. (canceled)

16. The computationally-implemented method of claim 1, wherein said determining that a device has particular data that is designated as potentially valuable wherein access to the particular data is restricted comprises:
determining that a device has stored particular data that is designated as potentially valuable, wherein access to the particular data is restricted.

17. (canceled)

18. The computationally-implemented method of claim 1, wherein said determining that a device has particular data that is designated as potentially valuable wherein access to the particular data is restricted comprises:
monitoring public data to determine a likelihood that the device has particular data that is designated as potentially valuable wherein access to the particular data is restricted.

19. The computationally-implemented method of claim 18, wherein said monitoring public data to determine a likelihood that the device has particular data that is designated as potentially valuable wherein access to the particular data is restricted comprises:
monitoring one or more social networking sites to determine a likelihood that the device has particular data that is designated as potentially valuable, wherein access to the particular data is restricted.

20. (canceled)

21. The computationally-implemented method of claim 1, wherein said determining that a device has particular data that is designated as potentially valuable wherein access to the particular data is restricted comprises:
determining that a device has particular data of a type that is designated as potentially valuable, wherein access to the particular data is restricted.

22. (canceled)

23. The computationally-implemented method of claim 1, wherein said determining that a device has particular data that is designated as potentially valuable wherein access to the particular data is restricted comprises:
determining that a device has particular data having one or more values designated as potentially valuable, wherein access to the particular data is restricted.

24. (canceled)

25. The computationally-implemented method of claim 1, wherein said determining that a device has particular data that is designated as potentially valuable wherein access to the particular data is restricted comprises:
determining that a device has a particular amount of data that is designated as potentially valuable, wherein access to the particular data is restricted.

26. (canceled)

27. The computationally-implemented method of claim 1, wherein said determining that a device has particular data that is designated as potentially valuable wherein access to the particular data is restricted comprises:
determining that a device has particular data that is designated, by an internal designation, as potentially valuable, wherein access to the particular data is restricted.

28. (canceled)

29. (canceled)

30. (canceled)

31. The computationally-implemented method of claim 1, wherein said determining that a device has particular data that is designated as potentially valuable wherein access to the particular data is restricted comprises:
receiving a designation of data as potentially valuable; and
determining that a device has particular data that matches the received designation of data as potentially valuable.

32. The computationally-implemented method of claim 31, wherein said receiving a designation of data as potentially valuable comprises:
receiving a designation of data as potentially valuable from an external entity.

33. (canceled)

34. (canceled)

35. (canceled)

36. (canceled)

37. (canceled)

38. The computationally-implemented method of claim 1, wherein said determining one or more services configured to be carried out on the device, said one or more services using the particular data to which the access is restricted comprises:
selecting one or more services configured to be carried out on the device, said one or more services using the particular data to which the access is restricted.

39. (canceled)

40. (canceled)

41. The computationally-implemented method of claim 1, wherein said determining one or more services configured to be carried out on the device, said one or more services using the particular data to which the access is restricted comprises:
requesting one or more services configured to be carried out on the device, said one or more services using the particular data to which the access is restricted; and
receiving at least one service in response to requesting the one or more services.

42. The computationally-implemented method of claim 1, wherein said determining one or more services configured to be carried out on the device, said one or more services using the particular data to which the access is restricted comprises:
determining one or more services to be carried out by the device by accessing one or more resources, said one or more services using the particular data to which the access is restricted.

43. The computationally-implemented method of claim 42, wherein said determining one or more services to be carried out by the device by accessing one or more resources, said one or more services using the particular data to which the access is restricted comprises:
determining one or more services to be carried out by the device by accessing one or more websites and/or databases, said one or more services using the particular data to which the access is restricted.

44. The computationally-implemented method of claim 1, wherein said determining one or more services configured to be carried out on the device, said one or more services using the particular data to which the access is restricted comprises:
determining one or more services to be carried out by the device, said one or more services requiring the particular data to which the access is restricted in order to be completed.

45. The computationally-implemented method of claim 1, wherein said determining one or more services configured to be carried out on the device, said one or more services using the particular data to which the access is restricted comprises:
determining one or more services to be carried out the device, wherein access to the particular data is a prerequisite for completing the one or more services.

46. The computationally-implemented method of claim 1, wherein said facilitating presentation of an offer to facilitate carrying out one or more services that use at least a portion of the particular data comprises:
facilitating display of an offer, at the device, to carry out the one or more services that use the particular data.

47. The computationally-implemented method of claim 46, wherein said facilitating display of an offer, at the device, to carry out the one or more services that use the particular data comprises:
instructing the device to display an offer to facilitate carrying out the one or more services that use the particular data.

48. (canceled)

49. (canceled)

50. (canceled)

51. The computationally-implemented method of claim 1, wherein said facilitating presentation of an offer to facilitate carrying out one or more services that use at least a portion of the particular data comprises:
facilitating presentation of an offer to facilitate carrying out one or more services that use the particular data at the device, in exchange for receiving access to the particular data used by the one or more services.

52. The computationally-implemented method of claim 51, wherein said facilitating presentation of an offer to facilitate carrying out one or more services that use the particular data at the device, in exchange for receiving access to the particular data used by the one or more services comprises:
facilitating presentation of an offer to facilitate carrying out one or more services that use the particular data at the device, in exchange for permission to use the particular data used by the one or more services.

53. The computationally-implemented method of claim 52, wherein said facilitating presentation of an offer to facilitate carrying out one or more services that use the particular data at the device, in exchange for permission to use the particular data used by the one or more services comprises:
facilitating presentation of an offer to facilitate carrying out one or more services that use the particular data at the device, in exchange for permission to use the particular data used by the one or more services for a purpose unrelated to the one or more services.

54. (canceled)

55. The computationally-implemented method of claim 1, wherein said acquiring the particular data designated as potentially valuable by facilitating carrying out the one or more services that are configured to use at least a portion of the particular data in a course of carrying out the one or more services comprises:
acquiring the particular data designated as potentially valuable; and
facilitating execution of the one or more services that are configured to use at least a portion of the particular data.

56. The computationally-implemented method of claim 55, wherein said acquiring the particular data designated as potentially valuable comprises:
polling the device for the particular data at one or more particular intervals.

57. The computationally-implemented method of claim 55, wherein said acquiring the particular data designated as potentially valuable comprises:
installing a collection application on the device configured to collect the particular data.

58. (canceled)

59. The computationally-implemented method of claim 55, wherein said facilitating execution of the one or more services that are configured to use at least a portion of the particular data comprises:
carrying out the one or more services using the received particular data; and
transmitting a result of carrying out the one or more services to the device.

60. The computationally-implemented method of claim 55, wherein said facilitating execution of the one or more services that are configured to use at least a portion of the particular data comprises:
transmitting an application configured to carry out the one or more services to the device.

61. The computationally-implemented method of claim 55, wherein said facilitating execution of the one or more services that are configured to use at least a portion of the particular data comprises:
transmitting an application configured to carry out the one or more services to the device and configured to monitor the particular data after carrying out the one or more services.

62. The computationally-implemented method of claim 1, wherein said acquiring the particular data designated as potentially valuable by facilitating carrying out the one or more services that are configured to use at least a portion of the particular data in a course of carrying out the one or more services comprises:
carrying out the one or more services using at least a portion of the particular data to carry out the one or more services; and
maintaining one or more access rights of at least a portion of the particular data designated as potentially valuable.

63. The computationally-implemented method of claim 62, wherein said maintaining one or more access rights of at least a portion of the particular data designated as potentially valuable comprises:
maintaining one or more credentials used to gain access to the particular data.

64. (canceled)

65. (canceled)

66. The computationally-implemented method of claim 62, wherein said maintaining one or more access rights of at least a portion of the particular data designated as potentially valuable comprises:
maintaining possession of an anonymized version of the particular data designated as potentially valuable.

67. The computationally-implemented method of claim 1, wherein said acquiring the particular data designated as potentially valuable by facilitating carrying out the one or more services that are configured to use at least a portion of the particular data in a course of carrying out the one or more services comprises:
acquiring the particular data designated as potentially valuable by providing access to one or more resources to the device for carrying out the one or more services that are configured to use at least a portion of the particular data.

68. The computationally-implemented method of claim 1, wherein said acquiring the particular data designated as potentially valuable by facilitating carrying out the one or more services that are configured to use at least a portion of the particular data in a course of carrying out the one or more services comprises:
facilitating presentation of a request to a user of the device, via the device, to install an application that tracks the particular data and that carries out at least a portion of the one or more services.

69. The computationally-implemented method of claim 1, wherein said acquiring the particular data designated as potentially valuable by facilitating carrying out the one or more services that are configured to use at least a portion of the particular data in a course of carrying out the one or more services comprises:
installing an application on the device that is configured to track the particular data and that carries out at least a portion of the one or more services.

70. The computationally-implemented method of claim 1, wherein said acquiring the particular data designated as potentially valuable by facilitating carrying out the one or more services that are configured to use at least a portion of the particular data in a course of carrying out the one or more services comprises:
storing the particular data at a location remote from the device, on behalf of the device, and carrying out the one or more services using the stored data.

71. (canceled)

72. A computationally-implemented system, comprising
circuitry for determining that a device has particular data that is designated as potentially valuable wherein access to the particular data is restricted;
circuitry for determining one or more services configured to be carried out on the device, said one or more services using the particular data to which the access is restricted;
circuitry for facilitating presentation of an offer to facilitate carrying out one or more services that use at least a portion of the particular data; and
circuitry for acquiring the particular data designated as potentially valuable by facilitating carrying out the one or more services that are configured to use at least a portion of the particular data in a course of carrying out the one or more services.

73-142. (canceled)

143. A device defined by a computational language comprising:
one or more interchained physical machines ordered for determining that a device has particular data that is designated as potentially valuable wherein access to the particular data is restricted;
one or more interchained physical machines ordered for determining one or more services configured to be carried out on the device, said one or more services using the particular data to which the access is restricted;
one or more interchained physical machines ordered for facilitating presentation of an offer to facilitate carrying out one or more services that use at least a portion of the particular data; and
one or more interchained physical machines ordered for acquiring the particular data designated as potentially valuable by facilitating carrying out the one or more services that are configured to use at least a portion of the particular data in a course of carrying out the one or more services.
